(19) United States
(12) Patent Application Publication
(10) Pub. No.: US 2022/0403187 A1
(43) Pub. Date: Dec. 22, 2022

(54) ACTIVE-ENERGY-RAY-CURABLE COMPOSITION, INK SET, COMPOSITION STORED CONTAINER, IMAGE FORMING APPARATUS, IMAGE FORMING METHOD, AND PRINTED MATTER

(71) Applicants: Yukiko ISHIJIMA, Tokyo (JP); Satoshi Kojima, Kanagawa (JP)

(72) Inventors: Yukiko ISHIJIMA, Tokyo (JP); Satoshi Kojima, Kanagawa (JP)

(73) Assignee: Ricoh Company, Ltd., Tokyo (JP)

(21) Appl. No.: 17/755,501

(22) PCT Filed: Dec. 22, 2020
(86) PCT No.: PCT/JP2020/047878

§ 371 Date: Apr. 29, 2022

(30) Foreign Application Priority Data
Dec. 26, 2019 (JP) 2019-237047
Feb. 12, 2020 (JP) 2020-021731

(51) Int. Cl. C09D 11/101; C09D 11/40; B65D 47/12; B41M 7/00

(52) U.S. Cl. CPC C09D 11/101; C09D 11/40; B65D 47/123; B41M 7/0081

(57) ABSTRACT

An active-energy-ray-curable composition includes at least two or more kinds of polymerizable monomers (A), where a homopolymer of each of the polymerizable monomers (A) has a glass transition temperature of 80 degrees Celsius or more. The polymerizable monomers (A) have a polymerizable monomer (A1) where a homopolymer of the polymerizable monomer (A1) has an SP value of 10.8 or more but 12.2 or less determined by Fedors method. An amount of the polymerizable monomer (A1) is 3% by mass or more but 20% by mass or less relative to a total amount of the active-energy-ray-curable composition.

### TECHNICAL FIELD

The present disclosure relates to an active-energy-ray-curable composition, an ink set, a composition stored container, an image forming apparatus, an image forming method, and a printed matter.

### BACKGROUND ART

Inkjet recording methods have been known as methods for forming images on recording media such as paper. The inkjet recording methods have a high ink con-sumption efficiency and an excellent resource saving efficiency, and can save the ink cost per unit recording.

Among the inkjet recording methods, inks for active-energy-ray-curable inkjet recording have recently attracted much attention as a system that has an excellent quick drying property, can be recorded on non-absorbable recording media, and does not cause images to bleed.

The inks for active-energy-ray-curable inkjet recording can be widely used for various recording media, and used for, for example, signage and building materials because of high productivity. As the ink for active-energy-ray-curable inkjet recording, for example, an ink, which includes an anchor coat composition containing silica to improve the blocking resistance, has been proposed (see, for example, PTL 1). Moreover, in order to improve the blocking resistance, the following has been proposed. Specifically, a polymerization initiator containing a plurality of radical generating sites is used to improve reactivity, and a molecular weight of a cured material is increased (see, for example, PTL 2). Furthermore, in addition to the polymerization initiator, an ink composition, which exhibits a good copolymerizability of N-vinyl lactams and tetrahydrofurfuryl acrylate, has been proposed (see, for example, PTL 3).

In addition, the inks for active-energy-ray-curable inkjet recording form images by ink droplets (ink dots). For the purpose of further improving the printing quality using the ink for active-energy-ray-curable inkjet recording, for example, the following printing method has been proposed. Specifically, an ink set (dark and light ink), which includes two kinds of inks: a black ink having a general pigment concentration; and a black ink (may be referred to as a light black ink) having a pigment concentration lower than the general pigment concentration, is used to hardly cause a difference in density of ink dots in the whole brightness region (see, for example, PTL 4).

### CITATION LIST

### Patent Literature

PTL 1: Japanese Unexamined Patent Application Publication No. 2019-198970
PTL 2: Japanese Unexamined Patent Application Publication No. 2010-116460
PTL 3: Japanese Unexamined Patent Application Publication No. 2010-222385
PTL 4: Japanese Unexamined Patent Application Publication No. 2003-238857

### SUMMARY OF INVENTION

### Technical Problem

An object of the present disclosure is to provide an active-energy-ray-curable composition, which does not deteriorate a liquid contact property and adhesiveness, exhibits excellent blocking resistance, and further can obtain an image excellent in a low odor, a low granular texture, and crack resistance of a coating film.

### Solution to Problem

According to one aspect of the present disclosure, an active-energy-ray-curable composition includes at least two or more kinds of polymerizable monomers (A) where a homopolymer of each of the polymerizable monomers (A) has a glass transition temperature of 80 degrees Celsius or more. The polymerizable monomers (A) have a polymerizable monomer (A1) where a homopolymer of the polymerizable monomer (A1) has an SP value of 10.8 or more but 12.2 or less determined by a Fedors method. An amount of the polymerizable monomer (A1) is 3% by mass or more but 20% by mass or less relative to a total amount of the active-energy-ray-curable composition.

### Advantageous Effects of Invention

According to the present disclosure, it is possible to provide an active-energy-ray-curable composition, which does not deteriorate a liquid contact property and adhesiveness, exhibits excellent blocking resistance, and further can obtain an image excellent in a low odor, a low granular texture, and crack resistance of a coating film.

### BRIEF DESCRIPTION OF DRAWINGS

FIG. 1 is a schematic view illustrating an example of an image forming apparatus including an inkjet ejection unit.

FIG. 2 is a schematic view illustrating another example of an image forming apparatus (apparatus to fabricate a 3D object).

FIG. 3A is a schematic view illustrating one example of a method for fabricating a three-dimensional object using an active-energy-ray-curable composition.

FIG. 3B is a schematic view illustrating one example of a method for fabricating a three-dimensional object using an active-energy-ray-curable composition.

FIG. 3C is a schematic view illustrating one example of a method for fabricating a three-dimensional object using an active-energy-ray-curable composition.

FIG. 3D is a schematic view illustrating one example of a method for fabricating a three-dimensional object using an active-energy-ray-curable composition.

### DESCRIPTION OF EMBODIMENTS

(Active-Energy-Ray-Curable Composition)

An active-energy-ray-curable composition of the present disclosure includes at least two or more kinds of polymerizable monomers (A) where a homopolymer of each of the polymerizable monomers (A) has a glass transition temperature of 80 degrees Celsius or more. The polymerizable monomers (A) have a polymerizable monomer (A1) where a homopolymer of the polymerizable monomer (A1) has an SP value of 10.8 or more but 12.2 or less determined by a Fedors method. An amount of the polymerizable monomer (A1) is 3% by mass or more but 20% by mass or less relative to a total amount of the active-energy-ray-curable composition. The active-energy-ray-curable composition of the present disclosure further includes another polymerizable monomer (B), a polymerization initiator (C), a polymerizable oligomer (G), a colorant, an organic solvent, and other components if necessary.

Conventional inks for active-energy-ray-curable inkjet recording have the following problem. Specifically, when cured materials are stacked, a blocking phenomenon, in which the cured material are transferred due to an influence of an unreacted monomer and the amount of a low molecular polymer, may occur in some cases. In order to improve the blocking resistance, inclusion of silica in an anchor coat composition has been proposed. However, when an amount of silica contained is increased, a problem that the adhesiveness may be deteriorated may occur.

In the conventional techniques, in order to improve the blocking resistance, the following has been proposed. Specifically, a polymerization initiator containing a plurality of radical generating sites is used to improve reactivity, and a molecular weight of a cured material is increased. However, this case has such a problem that an increased number of crosslinking points may cause curing shrinkage to decrease the adhesiveness.

In addition, in the conventional techniques, an ink composition, which exhibits a good copolymerizability of N-vinyl lactams and tetrahydrofurfuryl acrylate, has been proposed in addition to the polymerization initiator. However, there is a problem that the N-vinyl lactams such as N-vinylcaprolactam have a high SP value, and an adhesive used in an inkjet head may be swelled to cause ejection failures.

Furthermore, in the conventional techniques, an image formed by the ink for active-energy-ray-curable inkjet recording has the following problem. Specifically, sparsely formed dots (i.e., granulation) are caused in a region where the image density is low; i.e., a region to be printed where a density of the dots is low. Therefore, the dots may be noticeable.

The present inventors found that inclusion of a certain amount of a polymerizable monomer having certain physical properties as a polymerizable compound can obtain an active-energy-ray-curable composition, which does not affect materials used in a printing apparatus and can obtain an image (printing image) excellent in the adhesiveness to a substrate and the blocking resistance. Moreover, the present inventors found that it is possible to obtain an active-energy-ray-curable composition that can obtain an image (printing image) excellent in a low odor, a low granular texture, and crack resistance of a coating film.

-Polymerizable Monomer (A)-

The polymerizable monomers (A) include at least two or more kinds of polymerizable monomers where a homopolymer of each of the polymerizable monomers has a glass transition temperature of 80 degrees Celsius or more.

When the polymerizable monomers (A) include at least two or more kinds of polymerizable monomers where a homopolymer of each of the polymerizable monomers has a glass transition temperature of 80 degrees Celsius or more, the blocking resistance of the active-energy-ray-curable composition can be improved.

The glass transition temperature of the homopolymer refers to a glass transition temperature of a cured material of the homopolymer. When a catalog describes its value, the value of the glass transition temperature is employed. However, when the catalog does not describe a value of the glass transition temperature, the value of the glass transition temperature is measured by the differential scanning calorimetry (DSC) method.

A glass transition temperature of the homopolymer is 80 degrees Celsius or more, preferably 80 degrees Celsius or more but 155 degrees Celsius or less.

<Measurement of Glass Transition Temperature>

Polymerization of the monofunctional polymerizable monomer can be performed by the general solution polymerization method.

a: A toluene solution of the monofunctional polymerizable monomer (10% by mass)

b: Azobisisobutyronitrile (5% by mass) as a polymerization initiator

The a and the b are charged into a test tube while being purged with nitrogen, and the test tube is shaken for 6 hours in a warm bath of 60 degrees Celsius, to synthesize a polymer.

Then, the polymer is reprecipitated in a solvent (e.g., methanol and petroleum ether) that can dissolve the monofunctional polymerizable monomer and cannot dissolve the polymer. Then, the resultant is filtrated to extract the polymer.

The polymer obtained was subjected to DSC measurement.

For the DSC measurement, DSC120U available from Seiko Instruments is used. The measurement is performed at a measurement temperature of from 30 degrees Celsius through 300 degrees Celsius and a heating rate of 2.5 degrees Celsius per one minute.

The polymerizable monomers (A) include a polymerizable monomer (A1) where a homopolymer of the polymerizable monomer (A1) has an SP value of 10.8 or more but 12.2 or less determined by a Fedors method. When at least one of the polymerizable monomers (A) includes a polymerizable monomer (A1) where a homopolymer of the polymerizable monomer (A1) has an SP value of 10.8 or more but 12.2 or less determined by a Fedors method, it is possible to improve the liquid contact property (a property of swelling and deteriorating an adhesive used to assemble an ink ejection head) and the adhesiveness of the cured material of the active-energy-ray-curable composition to a substrate. Inclusion of two or more kinds of polymerizable monomers can achieve a good blocking resistance. Inclusion of the polymerizable monomer having an SP value of 10.8 or more can improve the adhesiveness. The SP value is 10.8 or more but 12.2 or less, preferably 10.8 or more but 11.4 or less.

The SP value is a solubility parameter, and is generally widely used as an indicator of affinity and solubility of, for example, a solvent, a resin, or a pigment.

A method for determining the SP value is not particularly limited and may be appropriately selected depending on the intended purpose. Examples of the method include: various methods such as a method where an SP value is measured by experiments, a method where an SP value is calculated from measurement of physical properties such as immersion heat, and a method where an SP value is calculated from the molecular structure; and a method where an SP value is calculated from the molecular structure advocated by Fedors. Among them, a method where an SP value is calculated from the molecular structure advocated by Fedors is preferable. This method is effective because an SP value can be calculated so long as its molecular structure is known, and a difference between an SP value obtained by this method and an SP value obtained through experiments is small.

In the Fedors's method, the evaporation energy of each atom or atomic group at 25 degrees Celsius is defined as Δei, and a molar volume is defined as Δvi. The values can be substituted for the following expression (A) to determine an SP value.

In the present disclosure, based on the Fedors's method, an SP value calculated from the molecular structure is used, and its unit is (cal/cm³)^{1/2}.

In the present disclosure, SP values at 25 degrees Celsius are used, and, for example, the temperature conversion is not performed.

The SP value can be calculated by using the Fedors method described in the following cited reference (cited reference: R. F. Fedors: Polym. Eng. Sci., 14 [2], 147-154).

The polymerizable monomer (A1) is not particularly limited and may be appropriately selected depending on the intended purpose, so long as it satisfies the aforementioned condition. Examples of the polymerizable monomer (A1) include 4-acryloylmorpholine, N-vinylcaprolactam, N-vinylpyrrolidone, and hydroxyethyl acrylamide. Furthermore, when the polymerizable monomer (A1) is 4-acryloylmorpholine, a change in viscosity obtained after the active-energy-ray-curable composition is stored can be prevented.

An amount of the polymerizable monomer (A1) is 3% by mass or more but 20% by mass or less, preferably 8% by mass or more but 20% by mass or less relative to the total amount of the composition. When the amount of the polymerizable monomer (A1) is 3% by mass or more, a recording medium can be sufficiently swelled to bear the adhesiveness. When the amount of the polymerizable monomer (A1) is 8% by mass or more, the adhesiveness can be improved. When the amount of the polymerizable monomer (A1) is 12% by mass or more, the adhesiveness can be further improved.

When the amount of the polymerizable monomer (A1) is 20% by mass or less, the adhesive used in a head is swelled, and it is possible to prevent nozzle-down caused by melting the adhesive. In addition, the amount of the polymerizable monomer (A1) satisfying 20% by mass or less can precisely control a piezo pressure to prevent occurrence of ejection failures in a piezoelectric ejection head.

The polymerizable monomers (A), which includes at least two or more kinds of polymerizable monomers (A) where a homopolymer of each of the polymerizable monomers (A) has a glass transition temperature of 80 degrees Celsius or more, preferably include a polymerizable monomer (A2) other than the polymerizable monomer (A1). Examples of the polymerizable monomer (A2) other than the polymerizable monomer (A1) include, but are not limited to, 4-t-butylcyclohexyl acrylate, 1-adamantylacrylate, isobornyl acrylate, isobornyl methacrylate, 3,3,5-trimethylcyclohexyl methacrylate, and dicyclopentadienyl methacrylate.

Preferably, the polymerizable monomers (A) where the homopolymer of each of the polymerizable monomers (A) has a glass transition temperature of 80 degrees Celsius or more further include a polymerizable polyfunctional monomer (A3) having at least two or more polymerizable functional groups. Inclusion of the polymerizable polyfunctional monomer (A3) having at least two or more polymerizable functional groups can improve the strength of a coating film and can obtain more excellent blocking resistance.

The polymerizable polyfunctional monomer is not particularly limited and may be appropriately selected depending on the intended purpose. Examples of the polymerizable polyfunctional monomer include 1,3-butylene glycol diacrylate, neopentyl glycol diacrylate, dipropylene glycol, tripropylene glycol, pentaerythritol tetraacrylate, ditrimethylolpropane tetraacrylate, dipentaerythritol pentaacrylate, ethoxylated bisphenol A dimethacrylate, ethoxylated (4) bisphenol A dimethacrylate, and 1,6-hexanediol diacrylate. These may be used alone or in combination.

An amount of the polymerizable polyfunctional monomer having at least two or more polymerizable functional groups is not particularly limited and may be appropriately selected depending on the intended purpose. The amount of the polymerizable polyfunctional monomer having at least two or more polymerizable functional groups is preferably 20% by mass or more but 48% by mass or less, more preferably 35% by mass or more but 45% by mass or less, relative to the total amount of the composition.

A total amount of the polymerizable monomers where the homopolymer of each of the polymerizable monomers has a glass transition temperature of 80 degrees Celsius or more is more preferably 35% by mass or more but 45% by mass or less. When the total amount is more than 45% by mass, there may be a high possibility that crack in the coating film may possibly occur at the time of winding a roll substrate because the coating film becomes fragile and the flexibility resistance becomes poor. Therefore, the total amount is preferably 45% or less.

<Other Polymerizable Monomers (B)>

Examples of the other polymerizable monomers (B) include phenoxyethyl acrylate, cyclic trimethylolpropane formal acrylate, stearyl acrylate, tetrahydrofurfuryl acrylate, isodecyl acrylate, tridecyl acrylate, octyl/decyl acrylate, 1,4-butanediol diacrylate, 1,6 hexanediol acrylate, cyclohexanedimethanol diacrylate, trimethylolpropane triacrylate, tetrahydrofurfuryl methacrylate, lauryl methacrylate, triethylene glycol dimethacrylate, and trimethylolpropane trimethacrylate. These may be used alone or in combination.

Inclusion of the other polymerizable monomers (B) is preferable because flexibility resistance of the coating film can be improved.

An amount of the other polymerizable monomers (B) is preferably 20% by mass or more but 60% by mass or less, more preferably 30% by mass or more but 50% by mass or less relative to the total amount of the composition.

<Polymerization Initiator (C)>

The active-energy-ray-curable composition of the present disclosure optionally contains a polymerization initiator. The polymerization initiator produces active species such as a radical or a cation upon application of energy of an active energy ray and initiates polymerization of a polymerizable compound (monomer or oligomer).

As the polymerization initiator, it is suitable to use a known radical polymerization initiator, cation polymerization initiator, base producing agent, or a combination thereof. Of these, a radical polymerization initiator is preferable. Moreover, the polymerization initiator preferably accounts for 5% by mass or more but 20% by mass or less of the total content of the composition (100% by mass) to obtain sufficient curing speed.

Specific examples of the radical polymerization initiators include, but are not limited to, aromatic ketones, acylphosphine oxide compounds, aromatic onium chlorides, organic peroxides, thio compounds (thioxanthone compounds, thiophenyl group containing compounds, etc.), hexaaryl biimidazole compounds, ketoxime ester compounds, borate compounds, azinium compounds, metallocene compounds, active ester compounds, compounds having a carbon halogen bond(s), and alkyl amine compounds.

In addition, a polymerization accelerator (sensitizer) is optionally used together with the polymerization initiator. The polymerization accelerator is not particularly limited. Preferred examples thereof include, but are not limited to, amines such as trimethylamine, methyl dimethanol amine, triethanol amine, p-diethylamino ace-tophenone, p-dimethyl amino ethylbenzoate, p-dimethyl amino benzoate-2-ethylhexyl, N,N-dimthyl benzylamine and 4,4′-bis(diethylamino)benzophenone. The content thereof is determined depending on the identity (type) of the polymerization initiator and the content thereof.

An amount of the polymerization initiator (C) is preferably 1% by mass or more but 20% by mass or less, more preferably 3% by mass or more but 15% by mass or less relative to the total amount of the composition.

<Polymerizable Oligomer (G)>

The polymerizable oligomer (G) means a polymer having a weight average molecular weight of 1,000 or more but 30,000 or less. The weight average molecular weight can be measured through, for example, gel permeation chromatography (GPC).

When the active-energy-ray-curable composition includes the polymerizable oligomer (G), an average molecular weight of the formed coating film is increased, and an image having a good flexibility can be obtained.

Examples of the polymerizable oligomer (G) include aromatic urethane acrylate oligomers, aliphatic urethane acrylate oligomers, epoxy acrylate oligomers, polyester acrylate oligomers, and other special polymerizable oligomers. These may be used alone or in combination.

As the polymerizable oligomer (G), a commercially available product can be used. Examples of the commercially available product include: UV-2000B, UV-2750B, UV-3000B, UV-3010B, UV-3200B, UV-3300B, UV-3700B, UV-6640B, UV-8630B, UV-7000B, UV-7610B, UV-1700B, UV-7630B, UV-6300B, UV-6640B, UV-7550B, UV-7600B, UV-7605B, UV-7610B, UV-7630B, UV-7640B, UV-7650B, UT-5449, and UT-5454 (all of which are available from The Nippon Synthetic Chemical Industry Co., Ltd.); CN902, CN902J75, CN929, CN940, CN944, CN944B85, CN959, CN961E75, CN961H81, CN962, CN963, CN963A80, CN963B80, CN963E75, CN963E80, CN963J85, CN964, CN965, CN965A80, CN966, CN966A80, CN966B85, CN966H90, CN966J75, CN968, CN969, CN970, CN970A60, CN970E60, CN971, CN971A80, CN971J75, CN972, CN973, CN973A80, CN973H85, CN973J75, CN975, CN977, CN977C70, CN978, CN980, CN981, CN981A75, CN981B88, CN982, CN982A75, CN982B88, CN982E75, CN983, CN984, CN985, CN985B88, CN986, CN989, CN991, CN992, CN994, CN996, CN997, CN999, CN9001, CN9002, CN9004, CN9005, CN9006, CN9007, CN9008, CN9009, CN9010, CN9011, CN9013, CN9018, CN9019, CN9024, CN9025, CN9026, CN9028, CN9029, CN9030, CN9060, CN9165, CN9167, CN9178, CN9290, CN9782, CN9783, CN9788, and CN9893 (all of which are available from SARTOMER); and EBECRYL210, EBECRYL220, EBECRYL230, EBECRYL270, KRM8200, EBECRYL5129, EBECRYL8210, EBECRYL8301, EBECRYL8804, EBECRYL8807, EBECRYL9260, KRM7735, KRM8296, KRM8452, EBECRYL4858, EBECRYL8402, EBECRYL9270, EBECRYL8311, and EBECRYL8701 (all of which are available from Daicel-Cytec Co Ltd).

An amount of the polymerizable oligomer (G) is preferably 1% by mass or more but 10% by mass or less relative to the total amount of the active-energy-ray-curable composition. When the amount of the polymerizable oligomer (G) is 1% by mass or more but 10% by mass or less relative to the total amount of the active-energy-ray-curable composition, an average molecular weight of the formed coating film is increased, and an image having a good flexibility can be obtained.

The surface tension of the polymerizable oligomer (G) does not affect glossiness of the coating film.

<Colorant>

The active-energy-ray-curable composition of the present disclosure may include a colorant.

The colorant may be appropriately selected depending on the intended purpose. Various pigments and dyes that impart colors such as black, white, magenta, cyan, and yellow can be used.

Examples of the pigment include inorganic pigments and organic pigments. These may be used alone or in combination.

Specific examples of the inorganic pigments include, but are not limited to, carbon blacks (C.I. Pigment Black 7) such as furnace black, lamp black, acetylene black, and channel black, iron oxides, and titanium oxides.

Specific examples of the organic pigments include, but are not limited to, azo pigments such as insoluble azo pigments, condensed azo pigments, azo lakes, and chelate azo pigments; polycyclic pigments such as phthalocyanine pigments, perylene pigments, perinone pigments, anthraquinone pigments, quinacridone pigments, dioxazine pigments, thioindigo pigments, isoindolinone pigments, and quinofuranone pigments; dye chelates (e.g., basic dye chelates and acid dye chelates); dye lakes (e.g., basic dye lakes and acid dye lakes); nitro pigments; nitroso pigments; aniline black; and daylight fluorescent pigments.

In addition, a dispersant may be included to enhance the dispersibility of the pigment. The dispersant is not particularly limited. Examples of the dispersant include dispersants such as polymer dispersants, which are conventionally used for preparing a pigment dispersion.

Examples of the dyes include acidic dyes, direct dyes, reactive dyes, and basic dyes. These may be used alone or in combination.

An amount of the colorant may be appropriately determined by considering, for example, a desired color density and dispersibility in the composition, and is not particularly limited. The amount of the colorant is preferably 0.1% by mass or more but 30% by mass or less relative to the total amount of the active-energy-ray-curable composition. Moreover, light cyan can be obtained by adjusting the amount of the cyan to 0.1% by mass or more but 5% by mass or less relative to the total amount of the active-energy-ray-curable composition, and light magenta can be obtained by adjusting the amount of the magenta to 0.1% by mass or more but 5% by mass or less relative to the total amount of the active-energy-ray-curable composition.

<Organic Solvent>

The active-energy-ray-curable composition of the present disclosure optionally contains an organic solvent, but preferably contains no organic solvent if possible. The active-energy-ray-curable composition free of an organic solvent, in particular volatile organic compound (VOC), is preferable because it enhances safety at where the composition is handled and makes it possible to prevent pollution of the environment. Inci-dentally, the organic solvent represents a conventional non-reactive organic solvent, for example, ether, ketone, xylene, ethyl acetate, cyclohexanone, and toluene, which is clearly distinguished from reactive monomers. Furthermore, “free of” an organic solvent means that no organic solvent is substantially contained. The content thereof is preferably less than 0.1% by mass.

<Other Components>

The active-energy-ray-curable composition of the present disclosure optionally contains other known components if necessary. The other known components are not particularly limited. Specific examples thereof include, but are not limited to, known articles such as surfactants, polymerization inhibitors, pigment dispersions (colorants), leveling agents, defoaming agents, fluorescent brighteners, permeation enhancing agents, wetting agents (humectants), fixing agents, viscosity stabilizers, fungicides, preservatives, antioxidants, ultraviolet absorbents, chelate agents, pH adjusters, (regulators), and thickeners.

<<Polymerization Inhibitor (D)>>

The polymerization inhibitor can enhance the storage property (storage stability) of the active-energy-ray-curable composition of the present disclosure. In addition, clogging of the head caused by thermal polymerization can be prevented when the active-energy-ray-curable composition of the present disclosure is heated to decrease the viscosity, followed by ejecting.

The polymerization inhibitor is not particularly limited and may be appropriately selected depending on the intended purpose. Examples of the polymerization inhibitor include 4-methoxyphenol, hydroquinone, benzoquinone, p-methoxyphenol, TEMPO, TEMPOL, and cupferron complexes of aluminum.

An amount of the polymerization inhibitor is preferably 200 ppm or more but 20,000 ppm or less relative to the total amount of the composition.

<<Hydrogen Donating Agent>>

The hydrogen donating agent is a compound that can donate hydrogen to a radical polymerization initiator as a compound having, for example, a benzophenone skeleton excited by irradiation of light.

The compound having, for example, a benzophenone skeleton as the radical polymerization initiator is a substance that initiates polymerization in the following mechanism of initiation of polymerization. That is, the compound having, for example, a benzophenone skeleton is in an excited state by irradiation of light. Then, the excited molecule extracts hydrogen from a nearby compound, and a radical is generated on the compound from which hydrogen is extracted, which becomes the starting point of radical polymerization. As a result, the compound having, for example, a benzophenone skeleton exhibits a function as a photoradical polymerization initiator. That is, when a compound from which hydrogen may be extracted exists together with the compound having, for example, a benzophenone skeleton, the mechanism of initiation of polymerization initiates polymerization. Therefore, for example, when hydrogen is extracted from a radically polymerizable compound used in the present disclosure, there may be a possibility that polymerization is initiated therefrom.

The hydrogen donating agent can smoothly give and receive hydrogen to/from a molecule of the compound having, for example, a benzophenone skeleton excited by irradiation of light, to allow polymerization to efficiently proceed. That is, addition of the hydrogen donating agent to the polymerization initiator can greatly improve polymerization reactivity with a low yellowing being maintained.

The hydrogen donating agent used in the present disclosure may be a compound that can smoothly donate hydrogen to a molecule of the compound having, for example, a benzophenone skeleton excited by irradiation of light.

Examples of the hydrogen donating agent include: compounds having an amino group (e.g., diethylamine, diphenylamine, triethylamine, tributylamine, di-ethanolamine, triethanolamine, N,N-diethylethanolamine, N,N-diethylmethylamine, dipropylamine, N,N-dimethylaniline, ethyl p-diethylaminobenzoate, and ethyl p-dimethylaminobenzoate); compounds having a hydroxyl group (e.g., methanol, ethanol, propanol, isopropyl alcohol, butanol, ethylene glycol, propylene glycol, butanediol, and phenol); compounds having an ether bond (e.g., tetrahydrofuran, tetrahy-dropyran, dioxane, trioxane, diethylene glycol, dipropylene glycol, propylene glycol monomethyl ether, and propylene glycol monomethylether acetate); mercapto compounds (e.g., butanthiol, propanethiol, hexanedithiol, decanedithiol, n-dodecyl mercaptan, dodecyl(4-methylthio)phenyl ether, benzenethiol, 4-dimethyl mercap-tobenzene, 2-mercaptoethanol, 1-mercapto-2-propanol, 3-mercapto-2-butanol, 3-mercapto-1,2-propanediol, and mercaptophenol) and disulfides obtained by oxidizing the foregoing compounds; and compounds having a mercapto group (e.g., butyl thioglycolate, ethylene glycol bisthioglycolate, ethylene glycol bisthiopropionate, butanediol bisβ-mercapto isobutyrate), 1,4-butanediol bisthioglycolate, 1,4-butanediol bisthiopropionate, octyl β-mercapto propionate, methoxybutyl β-mercapto propionate, trishydroxyethyl tristhiopropionate, trimethylolpropane trisβ-mercapto isobutyrate), trimethylolpropane trisβ-mercaptobutyrate), trimethylolpropane trisβ-mercapto propionate), trimethylolpropane tris(β-thiopropionate), trimethylolpropane tristhio-glycolate, trimethylolpropane tristhiopropionate, pentaerythritol tetrakisβ-mercapto propionate), pentaerythritol tetrakis thioglycolate, pentaerythritol tetrakis thiopropionate, thioglycolic acid, thiosalicy thiosalicylic acid lic acid, thiomalic acid, mer-captoacetic acid, 2-mercaptoethanesulfonic acid, 2-mercaptonicotinic acid, 2-mercaptopropionic acid, 3-mercaptopropanesulfonic acid, 3-mercaptopropionic acid, 3-mercaptobutyric acid, 4-mercaptobutanesulfonic acid, 3-[N-(2-mercaptoethyl)amino]propionic acid, 3-[N-(2-mercaptoethyl)carbamoyl]propionic acid, 2-mercapto-3-pyridinol, 2-mercaptoimidazole, 2-mercaptoethylamine, 2-mercaptobenzimidazole, 2-mercaptobenzothiazole, 6-trimercapto-s-triazine, N-(2-mercaptopropionyl)glycine, N-(3-mercaptopropionyl)alanine, diisopropylthioxanthone, diethylthioxanthone, thio-phosphites, and trimercaptopropionic acid tris(2-hydroxyethyl)isocyanurate).

As the hydrogen donating agent, compounds having an amino group are particularly suitably used because energy required for giving and receiving hydrogen is low. Among them, for example, methyl 2-(N,N-dimethylamino)benzoate, ethyl 4-(N,N-dimethylamino)benzoate, ethyl 4-(N,N-diethylamino)benzoate, and a mixture of 1,3-di({α-4-(dimethylamino)benzoyl poly[oxy(l-methylethylene)]}oxy)-2,2-bis({α-4-(dimethylamino)benzoyl poly[oxy(l-methylethylene)]}oxymethyl)propane and {α-4-(dimethylamino)benzoyl poly(oxyethylene)-poly[oxy(l-methylethylene)]-poly(oxyethylene)}4-(dimethylamino) benzoate (available from Lambson, “Speedcure7040”) are more preferable.

An amount of the hydrogen donating agent is preferably 0.01% by mass or more but 50% by mass or less, more preferably 0.1% by mass or more but 20% by mass or less relative to the polymerizable compounds in the composition.

<<Sensitizer>>

The sensitizer accelerates decomposition of the polymerization initiator by irradiation of active energy rays.

The sensitizer absorbs active energy rays to be in an electronically excited state, and contacts with the polymerization initiator in that state, to accelerate a chemical change of the polymerization initiator (e.g., decomposition and generation of radical, acid, or base) through action of, for example, electron transfer, energy transfer, and heat generation. A mass ratio of the sensitizer to the polymerization initiator is preferably 5×10⁻³ or more but 200 or less, more preferably 0.02 or more but 50 or less.

The sensitizer is not particularly limited and may be appropriately selected depending on the intended purpose. Examples of the sensitizer include sensitizing dyes that have an absorption wavelength in a region having a wavelength of 350 nm or more but 450 nm or less.

Examples of the sensitizer include polynucleus aromatic compounds (e.g., pyrene, perylene, and triphenylene), xanthenes (e.g., fluorescein, eosin, erythrosine, rhodamine B, and rose bengal), cyanines (e.g., thiacarbocyanine and oxacarbocyanine), mero-cyanines (e.g., merocyanine and carbomerocyanine), thiazines (e.g., thionin, methylene blue, and toluidine blue), acridines (e.g., acridine orange, chloroflavin, and acriflavine), anthraquinones (e.g., anthraquinone), squaryliums (e.g., squarylium), and coumarins (e.g., 7-diethylamino-4-methylcoumarin).

<<Cosensitizer>>

The cosensitizer further improves sensitivity of the sensitizing dye to active energy rays, and prevents polymerization inhibition of the polymerizable compound caused by oxygen.

The cosensitizer is not particularly limited and may be appropriately selected depending on the intended purpose. Examples of the cosensitizer include: amine-based compounds such as triethanolamine, p-dimethylamino aminobenzoic acid ethyl ester, p-formyldimethylaniline, and p-methylthiodimethylaniline; and thiols and sulfides such as 2-mercaptobenzothiazole, 2-mercapto benzoxazole, 2-mercaptobenzimidazole, 2-mercapto-4(3H)-quinazoline, and β-mercaptonaphthalene.

<<Plasticizer>>

The plasticizer can impart flexibility to a polymer formed of a monomer. Examples of the plasticizer include polyethylene glycol ester, terminally capped polyester, butyl stearate, lauric acid, dioctyl glutarate, triglyceride, dioctyl oxalate, triethyl phosphate, and acetyl tributyl citrate.

<<Thickener>>

Examples of the thickener include polycyano acrylate, polylactic acid, polyglycolic acid, polycaprolactone, polyacrylic acid alkyl ester, and polymethacrylic acid alkyl ester.

<<Antiseptic>>

Examples of the antiseptic include hitherto used substances that do not cause a monomer to initiate polymerization, such as potassium sorbate, sodium benzoate, sorbic acid, and chlorocresol.

The fiber reinforcing material is not particularly limited. Examples of the fiber reinforcing material include natural rubbers or synthetic rubbers such as styrene and acrylonitrile for reinforcing shock resistance of the composition.

<<Stabilizer>>

The stabilizer performs the function of suppressing polymerization of a monomer during storage. Examples of the stabilizer include anionic stabilizers and free radical stabilizers. Examples of the former include metaphosphoric acid, maleic acid, maleic anhydride, alkyl sulfonic acid, phosphorus pentaoxide, iron(III) chloride, antimony oxide, 2,4,6-trinitrophenol, thiol, alkyl sulfonyl, alkyl sulfone, alkyl sulfoxide, alkyl sulfite, sultone, sulfur dioxide, and sulfur trioxide. Examples of the latter include hydroquinone, catechol, and derivatives of these substances.

<Preparation of Active-Energy-Ray-Curable Composition>

The active-energy-ray-curable composition of the present disclosure can be prepared by using the components described above. The preparation devices and conditions are not particularly limited. For example, the curable—composition can be prepared by subjecting a polymerizable monomer, a pigment, a dispersant, etc., to a dispersion treatment using a dispersing machine such as a ball mill, a kitty mill, a disk mill, a pin mill, and a DYNO-MILL to prepare a pigment liquid dispersion, and further mixing the pigment liquid dispersion with a polymerizable monomer, an initiator, a polymerization inhibitor, and a surfactant.

<Volatilization Rate>

The active-energy-ray-curable composition of the present disclosure preferably has a volatilization rate (%) of 50% or less. The volatilization rate (%) is determined by dividing a value by mass G₁, the value being obtained by subtracting the mass G₁ from mass G₂, where the mass G₁ is mass of the active-energy-ray-curable composition obtained before the active-energy-ray-curable composition is left to stand still, and the mass G₂ is mass of the active-energy-ray-curable composition obtained after the active-energy-ray-curable composition is left to stand still for 5 days in a thermostat bath where a temperature is maintained at 60 degrees Celsius and a relative humidity is maintained at 30%.

It is believed that the odor of the active-energy-ray-curable composition is caused by volatilizing an uncured active-energy-ray-curable composition. The volatilization rate affects the odor of the active-energy-ray-curable composition. Therefore, when the volatilization rate of the active-energy-ray-curable composition is 50% or less, an image having a low odor can be obtained.

-Measurement Method of Volatilization Rate-

The measurement method of the volatilization rate can be performed in the following manner.

The active-energy-ray-curable composition (10 g) is charged into a dish having an outer diameter of 46 mm and a height of 18 mm. The volatilization rate is determined by dividing a value by mass G₁, the value being obtained by subtracting the mass G₁ from mass G₂, where the mass G₁ is mass of the active-energy-ray-curable composition obtained before the active-energy-ray-curable composition is left to stand still, and the mass G₂ is mass of the active-energy-ray-curable composition obtained after the active-energy-ray-curable composition is left to stand still for 5 days in a constant temperature and humidity bath where a temperature is maintained at 60 degrees Celsius and a relative humidity is maintained at 30%. When the initial weight of the ink (the mass obtained before the still standing) is defined as the G₁ and the weight of the ink obtained after the still standing (the mass obtained after it is left to stand still for 5 days) is defined as the G₂, the volatilization rate is calculated by the following expression (1).

The volatilization rate (%)={(G₂−G₁)/G₁}×100 expression (1)

The constant temperature and humidity bath is PL-2J available from ESPEC CORP., and the dish is a flat dish FS-45 available from AS ONE Corporation.

<Viscosity>

The viscosity of the active-energy-ray-curable composition of the present disclosure has no particular limit because it can be appropriately adjusted depending on the purpose and application devices. For example, if an ejecting device that ejects the composition from nozzles is employed, the viscosity thereof is preferably in the range of 3 mPa·s to 40 mPa·s, more preferably 5 mPa·s to 15 mPa·s, and particularly preferably 6 mPa·s to 12 mPa·s in the temperature range of 20 degrees C. to 65 degrees C., preferably at 25 degrees C. In addition, it is particularly preferable to satisfy this viscosity range by the composition free of the organic solvent described above. In-cidentally, the viscosity can be measured by a cone plate rotary viscometer (VISCOMETER TVE-22L, manufactured by TOKI SANGYO CO., LTD.) using a cone rotor (1°34′×R24) at a number of rotation of 50 rpm with a setting of the temperature of constant temperature circulating water in the range of 20 degrees C. to 65 degrees C. VISCOMATE VM-150III can be used for the temperature adjustment of the circulating water.

<Application Field>

The application field of the active-energy-ray-curable composition of the present disclosure is not particularly limited. It can be applied to any field where the active-energy-ray-curable compositions are used. For example, the curable composition is selected to a particular application and used for a resin for processing, a paint, an adhesive, an insulant, a releasing agent, a coating material, a sealing material, various resists, and various optical materials.

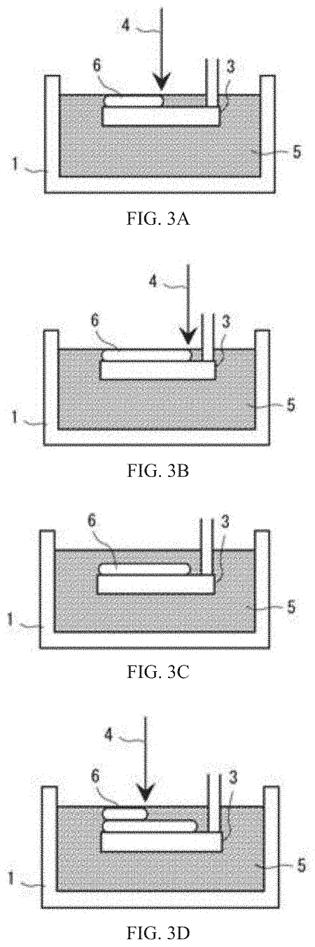

Furthermore, the active-energy-ray-curable composition of the present disclosure can be used as an ink to form two-dimensional texts, images, and designed coating film on various substrates and in addition as a solid object forming material to form a three-dimensional object. This three dimensional object forming material may also be used as a binder for powder particles used in a powder layer laminating method of forming a three-dimensional object by repeating curing and layer-forming of powder layers, and as a three-dimensional object constituent material (a model material) and a supporting member used in an additive manufacturing method (a stereolithography method) as illustrated in FIG. 2, FIG. 3A, FIG. 3B, FIG. 3C, and FIG. 3D. FIG. 2 is a diagram illustrating a method of additive manufacturing to sequentially form layers of the curable composition of the present disclosure one on top of the other by repeating discharging the active-energy-ray-curable composition of the present disclosure to particular areas followed by curing upon irradiation of an active energy ray. FIGS. 3A to 3D are each a diagram illustrating a method of additive manufacturing to sequentially form cured layers 6 having respective predetermined forms one on top of the other on a movable stage 3 by irradiating a storing pool (storing part) 1 of the active-energy-ray-curable composition 5 of the present disclosure with the active energy ray 4.

An apparatus for fabricating a three-dimensional object by the active-energy-ray-curable composition of the present disclosure is not particularly limited and can be a known apparatus. For example, the apparatus includes a containing device, a supplying device, and a discharging device of the curable composition, and an active energy ray irradiator.

In addition, the present disclosure includes cured materials obtained by curing the active-energy-ray-curable composition and processed products obtained by processing structures having the cured materials on a substrate. The processed product is fabricated by, for example, heat-drawing and punching a cured material or structure having a sheet-like form or film-like form. The processed product can suitably be used in applications necessary for molding a surface after decoration (e.g., meters or operation panels of vehicles, office machines, electric and electronic machines, and cameras).

The substrate is not particularly limited and may be appropriately selected depending on the intended purpose. Examples of the substrate include paper, thread, fiber, fabrics, leather, metal, plastic, glass, wood, ceramic, or composite materials thereof. Of these, plastic substrates are preferred in terms of processability.

The active-energy-ray-curable composition of the present disclosure can be particularly suitably used for, for example, inkjet applications.

(Ink set)

An ink set of the present disclosure includes: a black ink; a cyan ink; a yellow ink; a magenta ink; and a white ink. At least one selected from the group consisting of the black ink, the cyan ink, the yellow ink, the magenta ink, and the white ink in the ink set includes the active-energy-ray-curable composition of the present disclosure and a colorant.

As the colorant in the ink set of the present disclosure, the same colorant as the colorant used in the active-energy-ray-curable composition of the present disclosure can be used.

Preferably, the ink set of the present disclosure further includes a light cyan ink and a light magenta ink.

The light cyan ink means a cyan ink in which an amount of a solid content of the colorant is 0.1% by mass or more but 5% by mass or less relative to the total amount of the composition.

The light magenta ink means a magenta ink in which an amount of a solid content of the colorant is 0.1% by mass or more but 5% by mass or less relative to the total amount of the composition.

<Composition Stored Container>

The composition stored container of the present disclosure contains the active-energy-ray-curable composition or the ink and is suitable for the applications as described above. For example, if the active-energy-ray-curable composition of the present disclosure is used for ink, a container that stores the ink can be used as an ink bottle. Therefore, users can avoid direct contact with the ink during operations such as transfer or replacement of the ink, so that fingers and clothes are prevented from con-tamination. The stored container includes: a spout provided with a sealing film; and a cap body that is screwed with the spout, and an independent ring-shaped opening preventing member is provided, the independent ring-shaped opening preventing member being provided between an inner cap of the cap body and a main body of the cap body, and being configured to prevent rotation in an opening direction in an unused state. Therefore, this configuration is more preferable because inclusion of foreign substances caused before the stored container is opened can be prevented, and whether the stored container is used or not can be confirmed. In addition, the container can be of any size, any form, and any material. For example, the container can be designed to a particular application. It is preferable to use a light blocking material to block the light or cover a container with a light blocking sheet, etc.

The composition stored container of the present disclosure includes a container and the active-energy-ray-curable composition of the present disclosure stored in the container.

(Image Forming Method and Image Forming Apparatus)

An image forming method of the present disclosure may be performed using an active energy ray and/or while applying heat. The image forming method in accordance with some embodiments of the present invention includes at least an irradiating step of irradiating the curable composition of the present disclosure with an active energy ray to cure the curable composition. The image forming apparatus of the present disclosure includes at least an irradiator to irradiate the curable composition of the present disclosure with an active energy ray and a storing part containing the active-energy-ray-curable composition of the present disclosure. The storing part may include the container mentioned above. Note that, in the following description, the active-energy-ray-curable composition of the present disclosure may be merely referred to as an ink.

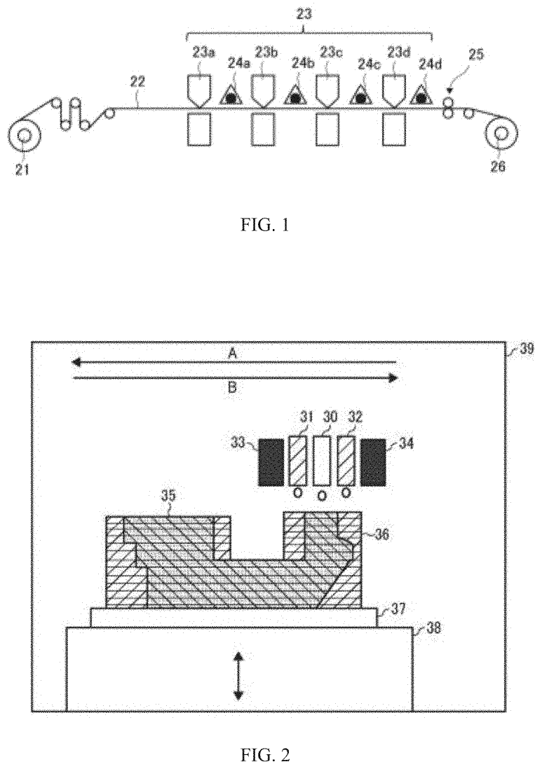

FIG. 1 is a diagram illustrating an image forming apparatus equipped with an inkjet discharging device. Printing units 23a, 23b, 23c, and 23d respectively having ink supply units and discharging heads for the active-energy-ray-curable inks of yellow, magenta, cyan, and black discharge the inks onto a recording medium 22 fed from a supplying roller 21. Thereafter, light sources 24a, 24b, 24c, and 24d configured to cure the inks emit active energy rays to the inks, thereby curing the inks to form a color image. Thereafter, the recording medium 22 is conveyed to a processing unit 25 and a printed matter reeling roll 26. Each of the printing unit 23a, 23b, 23c and 23d may have a heating mechanism to liquidize the ink at the ink discharging portion. Moreover, in another embodiment of the present disclosure, a mechanism may optionally be included to cool down the recording medium to around room temperature in a contact or non-contact manner. In addition, the inkjet recording method may be either of serial methods or line methods. The serial methods include discharging an ink onto a recording medium by moving the head while the recording medium inter-mittently moves according to the width of a discharging head. The line methods include discharging an ink onto a recording medium from a discharging head held at a fixed position while the recording medium continuously moves.

The recording medium 22 is not particularly limited. Specific examples thereof include, but are not limited to, paper, film, ceramics, glass, metal, and composite materials thereof, each of which may be in the form of a sheet. The image forming apparatus may have a one-side printing configuration and/or a two-side printing configuration. The recording medium is not limited to articles used as typical recording media. Examples of articles usable as the recording medium include cardboard, building materials (such as wall paper and floor material), concrete, cloth for apparel (such as T-shirts), textile, and leather as the recording medium.

Optionally, multiple colors can be printed with no or weak active energy ray from the light sources 24a, 24b, and 24c followed by irradiation of the active energy ray from the light source 24d. As a result, energy and cost can be saved.

The recorded matter having images printed with the ink of the present disclosure includes articles having printed images or texts on a plain surface of conventional paper, resin film, etc., a rough surface, or a surface made of various materials such as metal or ceramic. In addition, by laminating layers of images in part or the entire of a recording medium, a partially stereoscopic image (formed of two dimensional part and three-dimensional part) and a three dimensional objects can be fabricated.

FIG. 2 is a schematic diagram illustrating another example of the image forming apparatus (apparatus to fabricate a 3D object) of the present disclosure. An image forming apparatus 39 illustrated in FIG. 2 sequentially forms thin layers one on top of the other using a head unit having inkjet heads arranged movable in the directions indicated by the arrows A and B. In the image forming apparatus 39, an ejection head unit 30 for additive manufacturing ejects a first curable composition, and ejection head units 31 and 32 for support and curing these compositions ejects a second curable composition having a different composition from the first curable composition, while ultraviolet irradiators 33 and 34 adjacent to the ejection head units 31 and 32 cure the compositions.

To be more specific, for example, after the ejection head units 31 and 32 for support eject the second curable composition onto a substrate 37 for additive manufacturing and the second active-energy-ray-curable composition is solidified by irradiation of an active energy ray to form a first substrate layer having a space for composition, the ejection head unit 30 for additive manufacturing ejects the first curable composition onto the pool followed by irradiation of an active energy ray for solidification, thereby forming a first additive manufacturing layer. This step is repeated multiple times lowering the stage 38 movable in the vertical direction to laminate the supporting layer and the additive manufacturing layer to fabricate a solid object 35. Thereafter, an additive manufacturing support 36 is removed, if desired. Although only a single ejection head unit 30 for additive manufacturing is provided to the image forming apparatus illustrated 39 in FIG. 2, it can have two or more units 30.

<Inkjet Ejection Unit>

An inkjet ejection unit (hereinafter, may be referred to as “ink ejection head”) includes a liquid chamber, a nozzle plate having a nozzle hole, and a flow path, and a member that is in contact with the active-energy-ray-curable ink as the composition of the present disclosure is preferably joined with an epoxy adhesive. The epoxy adhesive is preferable in terms of the adhesive force and the hardness.

<<Liquid Chamber>>

The liquid chamber is space in the ink ejection head, in which an ink is filled. A shape of the liquid chamber is not particularly limited and a known liquid chamber may be appropriately selected depending on the intended purpose. The liquid chambers are individually disposed correspondingly to a plurality of nozzle holes provided in the nozzle plate, and are a plurality of individual flow paths that are communication with the nozzle holes. The liquid chambers may also be referred to as pressurizing liquid chambers, pressure chambers, ejection chambers, and pressurizing chambers.

<<Nozzle Plate>>

The nozzle plate includes a nozzle substrate and an ink-repellent film on the nozzle substrate.

The nozzle plate (hereinafter, may be referred to as “nozzle plate”) is not particularly limited and known nozzle plates may be appropriately selected depending on the intended purpose, so long as it has a nozzle hole.

The nozzle hole means a hole configured to eject liquid droplets of the ink.

<<<Nozzle Substrate>>>

The nozzle substrate is provided with a nozzle hole, and the number, shape, size, material, and structure thereof are not particularly limited and may be appropriately selected depending on the intended purpose.

The nozzle substrate includes: a nozzle surface at an ink ejection side at which the ink is ejected from the nozzle hole; and a liquid chamber-joined surface positioned opposite to the surface at the ink ejection side.

The material of the nozzle substrate is not particularly limited and may be appropriately selected depending on the intended purpose. Examples of the material include stainless steel, Al, Bi, Cr, InSn, ITO, Nb, Nb₂O₅, NiCr, Si, SiO₂, Sn, Ta₂O₅, Ti, W, ZAO (ZnO+Al₂O₃), and Zn. These may be used alone or in combination. Among them, stainless steel is preferable in terms of the rust preventing property.

Regarding the nozzle substrate, an ink-repellent film is preferably formed on a nozzle surface at the ink ejection side of the nozzle substrate.

<<<Ink-Repellent Film>>>

The ink-repellent film is formed on the nozzle surface of the nozzle substrate at the ink ejection side at which the nozzle substrate has the plurality of recess parts. For example, the shape, structure, material, and thickness of the ink-repellent film are not particularly limited and may be appropriately selected depending on the intended purpose.

The material of the ink-repellent film is not particularly limited and may be appropriately selected depending on the intended purpose. Examples of the material of the ink-repellent film include silicone resins and perfluoro polyether compounds because they are excellent in repellency against the ink.

<<Flow Path>>

The flow path means a path of the active-energy-ray-curable composition passing through the liquid chamber and the nozzle plate.

The phrase “member that is in contact with the active-energy-ray-curable composition is joined with an epoxy adhesive” means that at least one selected from the group consisting of a member constituting the liquid chamber, a member constituting the nozzle plate, and a member constituting the flow path is joined with an epoxy adhesive at one or more portions.

-Epoxy Adhesive-

The epoxy adhesive used in the joints in the inkjet ejection unit includes an epoxy compound and a curing agent, and further includes other components if necessary.

Note that, the epoxy adhesive means it also includes an epoxy-based adhesive including an epoxy compound as a main component.

The epoxy compound is not particularly limited and may be appropriately selected depending on the intended purpose. Examples of the epoxy compound include bisphenol A-type epoxy compounds, bisphenol F-type epoxy compounds, bisphenol S-type epoxy compounds, hydrogenated bisphenol A-type epoxy compounds, phenol novolak-type epoxy compounds, cresol novolak-type epoxy compounds, glycidyl ester-type epoxy compounds, glycidylamine-type epoxy compounds, alicyclic epoxy compounds, urethane-modified epoxy compounds, polysulfide-modified epoxy compounds, rubber-modified epoxy compounds (modified by, for example, CTBN: butadiene-acrylonitrile copolymer liquid rubber having a carboxyl group at its terminal, and ATBN: butadiene-acrylonitrile copolymer liquid rubber having an amino group at its terminal), polyalkylene glycol-type epoxy compounds, ether elastomer-added bisphenol A-type epoxy compounds, liquid urethane resin-added bisphenol A-type epoxy compounds, and dimer acid-modified epoxy compounds.

These may be used alone or in combination.

As a reactive diluent of the epoxy compound, an epoxy compound having a low viscosity such as n-butyl glycidyl ether or styrene oxide may be used.

The joint parts of the nozzle plate, a stimulus generating unit that will be described hereinafter, and members (e.g., a flow path plate and a vibration plate that will be described hereinafter) positioned between the nozzle plate and the stimulus generating unit are joined with an epoxy adhesive. Such a case that the joint parts are in contact with the active-energy-ray-curable composition is particularly preferable.

The member that is in contact with the active-energy-ray-curable composition is not particularly limited and may be appropriately selected depending on the intended purpose, so long as it can be in contact with the active-energy-ray-curable composition. Examples of the member include a member constituting the liquid chamber, a member constituting the nozzle plate, a member constituting the flow path, and a member constituting the stimulus generating unit.

<<Stimulus Generating Unit>>

The stimulus generating unit is a unit configured to generate a stimulus to be applied to the active-energy-ray-curable composition.

Examples of the stimulus generating unit include heating devices, pressure devices, piezoelectric elements, vibration generating devices, ultrasonic oscillators, and lights. Specific examples of the stimulus generating unit include: a piezoelectric actuator such as a piezoelectric element; a thermal actuator that uses an electrothermal conversion element such as a heating resistor and utilizes phase change caused by film boiling of an ink; a shape memory alloy actuator that utilizes a metal phase change caused by a temperature change; and an electrostatic actuator that utilizes electrostatic force.

<Curing Means>

The curable ink in accordance with some embodiments of the present invention comprises a curable composition. Preferably, the active-energy-ray-curable composition is cured by application of heat or irradiation with an active energy ray, and the latter is more preferable.

<<Active Energy Ray>>

The active energy ray used for curing the active-energy-ray-curable composition of the present disclosure is not particularly limited, so long as it can impart energy required for accelerating polymerization reaction of the polymerizable component in the composition. Specific examples of the active energy ray include, but are not limited to, electron beams, α-rays, β-rays, γ-rays, and X-rays, in addition to ultraviolet rays. When a light source having a particularly high energy is used, polymerization reaction can be allowed to proceed without a polymerization initiator. In addition, in the case of irradiation with ultraviolet ray, mercury-free is preferred in terms of protection of environment. Therefore, replacement with GaN-based semiconductor ultraviolet light-emitting devices is preferred from industrial and environmental point of view. Furthermore, ultraviolet light-emitting diode (UV-LED) and ultraviolet laser diode (UV-LD) are preferable as an ultraviolet light source. Small sizes, long time working life, high efficiency, and high cost performance make such irradiation sources desirable.

(Printed Matter)

A printed matter of the present disclosure includes the cured material obtained by curing the active-energy-ray-curable composition of the present disclosure.

### EXAMPLES

Hereinafter, the present disclosure will be described by way of Examples. However, the present disclosure should not be construed as being limited to these Examples.

### Examples 1 to 27 and Comparative Examples 1 to 6

The following materials (A) to (D) and (G) were mixed at mixing rates presented in Tables 2 to 10 (the numerical values are presented by part(s) by weight) to obtain active-energy-ray-curable inks 1 to 33.

(A1): Polymerizable monomers (A1) in which a glass transition temperature of the homopolymer is 80 degrees Celsius or more and an SP value of the homopolymer determined by a Fedors method is 10.8 or more but 12.2 or less.

(A2): Polymerizable monofunctional monomers other than the A1 in which a glass transition temperature of the homopolymer is 80 degrees Celsius or more.

(A3): Polymerizable polyfunctional monomers including a homopolymer having a glass transition temperature of 80 degrees Celsius or more.

(B): Polymerizable monomers other than the A1, the A2, and the A3

(C): Polymerization initiators

(D): Other components (polymerization inhibitor, surfactant, colorants (pigment dispersions))

(G): Polymerizable oligomer

The product names and manufacturers' names of the materials used are presented in Table 1.

Here, regarding the glass transition temperature, when a catalog of a maker of the polymerizable monomer described a value of the glass transition temperature, the value in the catalog was employed. However, when the catalog did not describe a value of the glass transition temperature, the value of the glass transition temperature was measured by the differential scanning calorimetry (DSC) method in the following manner.

In Examples 22 and 23, and Examples 25 and 26, an amount of a solid content of the pigment relative to the total amount of the composition was adjusted to 0.8% by mass to obtain a light cyan ink, and an amount of a solid content of the pigment relative to the total amount of the composition was adjusted to 0.4% by mass to obtain a light magenta ink.

<Measurement of Glass Transition Temperature>

Polymerization of the monofunctional polymerizable monomer was performed by the general solution polymerization method.

a: A toluene solution of the monofunctional polymerizable monomer (10% by mass)

b: Azobisisobutyronitrile (5% by mass) as a polymerization initiator

The a and the b were charged into a test tube while being purged with nitrogen, and the test tube was shaken for 6 hours in a warm bath of 60 degrees Celsius, to synthesize a polymer.

Then, the polymer was reprecipitated in a solvent (e.g., methanol and petroleum ether) that can dissolve the monofunctional polymerizable monomer and cannot dissolve the polymer. Then, the resultant was filtrated to extract the polymer.

The polymer obtained was subjected to DSC measurement.

For the DSC measurement, DSC120U obtained from Seiko Instruments was used.

The measurement was performed at a measurement temperature of from 30 degrees Celsius through 300 degrees Celsius and a heating rate of 2.5 degrees Celsius per one minute.

The pigment dispersions as the colorant, which were used in the active-energy-ray-curable inks, were prepared in the following manners.

<Preparation of Black Pigment Dispersion>

The materials having the following formulations were charged into a 100 ml ball mill filled with zirconia beads having a diameter of 2 mm and were pulverized at 70 rpm for 48 hours. Then, the resultant was charged into a sand mill filled with zirconia beads having a diameter of 0.1 mm and was dispersed at a peripheral speed of 8 m/s for 3 hours, to obtain a black pigment dispersion.
Carbon black (Special Black 250: obtained from Orion): 20 parts by mass
Dispersant (BYKJET-9151: obtained from BYK-Chemie): 8 parts by mass
Monomer (phenoxyethyl acrylate: obtained from OSAKA ORGANIC CHEMICAL INDUSTRY LTD.): 72 parts by mass

<Preparation of Cyan Pigment Dispersion>

The materials having the following formulations were charged into a 100 ml ball mill filled with zirconia beads having a diameter of 2 mm and were pulverized at 70 rpm for 48 hours. Then, the resultant was charged into a sand mill filled with zirconia beads having a diameter of 0.1 mm and was dispersed at a peripheral speed of 8 m/s for 3 hours, to obtain a cyan pigment dispersion.
Cyan pigment (PB15:4: D7110F, obtained from BASF): 20 parts by mass
Dispersant (SOLSPERSE 32000: obtained from The Lubrizol Corporation): 8 parts by mass
Monomer (phenoxyethyl acrylate: obtained from OSAKA ORGANIC CHEMICAL INDUSTRY LTD.): 72 parts by mass

<Preparation of Magenta Pigment Dispersion>

The materials having the following formulations were charged into a 100 ml ball mill filled with zirconia beads having a diameter of 2 mm and were pulverized at 70 rpm for 48 hours. Then, the resultant was charged into a sand mill filled with zirconia beads having a diameter of 0.1 mm and was dispersed at a peripheral speed of 8 m/s for 3 hours, to obtain a magenta pigment dispersion.
Magenta pigment (PR122: RGT: obtained from DIC Corporation): 20 parts by mass
Dispersant (BYK9151: obtained from BYK Japan): 8 parts by mass
Monomer (phenoxyethyl acrylate: obtained from OSAKA ORGANIC CHEMICAL INDUSTRY LTD.): 72 parts by mass

Next, the prepared active-energy-ray-curable ink was used to form an image using an ink ejection head produced in the following manner. The prepared active-energy-ray-curable ink was stored in a stored container including a spout provided with a sealing member, a cap body screwed with the spout, and a ring-shaped opening preventing member. At this time, it was confirmed that there was no inclusion of foreign substances before opening of the stored container.

<Production of Ink Ejection Head Using Epoxy Adhesive>

First, bisphenol A-type epoxy compound (product name: jER828, obtained from Mitsubishi Chemical Corporation) (40.0% by mass), bisphenol F-type epoxy compound (product name: jER806, obtained from Mitsubishi Chemical Corporation) (20.0% by mass), p-aminophenol-type epoxy compound (product name: jER630, obtained from Mitsubishi Chemical Corporation) (20.0% by mass), and silica (product name: AEROSIL R972, obtained from NIPPON AEROSIL CO., LTD.) (2.0% by mass) were added in this order, and were mixed under stirring so that the resultant would be uniform. Then, an amine adduct (product name: AJICURE MY-24, obtained from Ajinomoto Fine-Techno Co., Inc.) (18.0% by mass) was further added and mixed under stirring so that the resultant would be uniform, to prepare an epoxy adhesive.

The epoxy adhesive was used to join a member constituting the liquid chamber, a member constituting the nozzle plate, and a member constituting the flow path, all of which were members that would be in contact with the active-energy-ray-curable composition, to produce an ink ejection head (obtained from RICOH Company, Ltd., MH5440 model) including the liquid chamber, the nozzle plate having nozzle holes, and the flow path.

<Image Formation>

The produced ink ejection head (MH5440 model) was used to perform inkjet ejection on a substrate (polycarbonate), to form a solid image (3 cm×10 cm). An amount of ink droplets ejected was adjusted so that a thickness of the solid coating film would be about 10 micrometers. The active-energy-ray-curable ink obtained in the aforementioned manner was found to have a viscosity of from 8 mPa·s through 15 mPa·s at an ejection temperature of from 25 degrees Celsius through 40 degrees Celsius.

The active-energy-ray-curable ink ejected on the substrate was cured by irradiation of light using an UV irradiator LH6 (obtained from Fusion Systems Japan Co., Ltd.). The active-energy-ray-curable ink was cured in a wavelength region corresponding to the UVA region at 1 W/cm² under the light quantity condition of 3 J/cm². The solid coating film cured as described above was used as an image for evaluation.

Next, the active-energy-ray-curable ink and the image that had been produced were evaluated for “liquid contact property”, “blocking resistance”, “adhesiveness”, “storage property”, “flexibility”, “odor”, “crack resistance of coating film”, and “granularity” in the following manners. Results are presented in Tables 2 to 6.

<Liquid Contact Property>

A decrease rate of an elastic modulus expressed by the following expression (1) is preferably 20% or less, more preferably 10% or less, where E1 (GPa) is an elastic modulus of the cured material obtained by curing the epoxy adhesive at 90 degrees Celsius for 4 hours, and E2 (GPa) is an elastic modulus of the immersed matter obtained after the cured material was immersed in the active-energy-ray-curable ink at 60 degrees Celsius for 4 weeks.

A decrease in the elastic modulus decreases the ejection stability. The ejection stability was evaluated as follows. Specifically, the number of nozzles in which the elastic modulus was changed by 20% or more was 20 ch or less per 320 ch, which was considered as “acceptable”. The decrease rate of the elastic modulus was 20% or less, which was considered as being in the acceptable range. Here, the scores of 1 and 2 were considered to be practical.

The decrease rate (%) of the elastic modulus={(E1−E2)/E1}×100 expression (1)

--Evaluation Criteria--

2: The decrease rate of the elastic modulus was 10% or less.

1: The decrease rate of the elastic modulus was 20% or less.

0: The decrease rate of the elastic modulus was more than 20%.

<Blocking Resistance>

Immediately after curing, a substrate was stacked on the image produced by the image forming method so that the back surface of the substrate and the image faced each other. Then, they were maintained for 24 hours while pressure of 500 g/cm² was applied thereto in an oven of 40 degrees Celsius. Then, when the substrate was taken off, a degree of the image transferred onto the back surface of the substrate was observed.

The evaluation was performed based on the following evaluation criteria according to an area of the image transferred onto the back surface of the substrate.

Here, the transfer concentration was not evaluated. When the back surface of the substrate onto which color was transferred was visually confirmed, the image was considered to be transferred. Here, the scores of 1, 2, and 3 in the evaluation criteria were considered to be practical.

--Evaluation Criteria--

3: The cured material was not transferred.

2: Only the edge of the cured material was transferred.

1: Less than 20% of an area of the cured material was transferred.

0: 20% or more of an area of the cured material was transferred.

<Adhesiveness>

The cured material produced on the polycarbonate substrate by the image forming method was evaluated for adhesiveness using the following cutting tools and procedures according to the cross-cut adhesion test (old standard) of JIS K5400.

<<Tools>>
Cutting tool: cutter knife A-300 (obtained from NT Incorporated)
Guide and equal interval spacer: obtained from Kotec Ltd., cross-cut adhesion test guide, CCJ-1 (cutting intervals: 1 mm)
Transparent pressure-sensitive adhesive tape (hereinafter, referred to as “tape”): obtained from NICHIBAN CO., LTD., CELLOTAPE (registered trademark) CT-18

<<Procedure>>

A test plate was placed on a flat surface, and was cut at 1 mm intervals using the cutting tool and the equal interval spacer.

The number of cut lines in each direction was 11.

All the cut lines should be penetrated into the surface of the substrate.

So that lattice patters could be formed, the second cut lines were drawn on the first cut lines at an angle of 90°. Eleven parallel cut lines were drawn to form 100 square parts.

The tape was pulled at a certain rate, and was cut into a piece having a length of about 75 mm.

A piece of tape having a length of 50 mm or more was attached thereon so that a center of one line on the cut cured product was overlapped with a center of the piece of tape in a longitudinal direction.

In order to precisely contact the tape piece with the coating film, the tape piece was thoroughly rubbed with fingers.

The color of the coating film seen through the tape piece is an effective indicator as to whether the whole contact is in a good condition.

The tape piece was exfoliated one to two minutes after the tape piece was allowed to adhere thereto.

The edge of the tape piece was hold at a right angle to the surface of the coating film, and was exfoliated in a moment.

The adhesiveness of 100 means that no exfoliated portion in 100 cross-cut portions was found (an exfoliated area was 0%). For example, the adhesiveness of 70 means that an area of non-exfoliated portions was 70%. Here, the scores of 1 and 2 in the evaluation criteria were considered to be practical.

--Evaluation Criteria--

2: The adhesiveness was 95 or more but 100 or less.

1: The adhesiveness was 70 or more but 94 or less.

0: The adhesiveness was less than 70.

<Storage Property>

The viscosity of the ink, which had been left to stand still at 60 degrees Celsius for 1 week, was measured. Then, a change rate of the ink after the storage relative to the ink before the storage was evaluated. The viscosity of the ink was measured by a cone plate rotary viscometer (VISCOMETER TVE-22L, obtained from TOKI SANGYO CO., LTD.) using a cone rotor (1°34′×R24) at a number of rotation of 50 rpm with the temperature of constant temperature circulating water being appropriately set in the range of from 20 degrees Celsius through 65 degrees Celsius. VISCOMATE VM-150III was used for the temperature adjustment of the circulating water. Here, the scores of 1 and 2 in the evaluation criteria were considered to be practical.

--Evaluation Criteria--

2: The change rate of the viscosity was less than 5%.

1: The change rate of the viscosity was less than 10%.

0: The change rate of the viscosity was 10% or more.

<Flexibility>

The cured material obtained immediately after the cuing was wound around a main pipe having a radius of 10 mm. At this time, a state of the coating film was visually observed, and was evaluated based on the following evaluation criteria. Here, the scores of 1 and 2 in the evaluation criteria were considered to be practical.

--Evaluation Criteria--

2: No crack was found.

1: Minute crack was found.

0: Cracks were found.

<Volatilization Rate>

The active-energy-ray-curable composition (10 g) was charged into a dish having an outer diameter of 46 mm and a height of 18 mm. The volatilization rate was determined by dividing a value by mass G₁, the value being obtained by subtracting the mass G₁ from mass G₂, where the mass G₁ was mass of the active-energy-ray-curable composition obtained before the active-energy-ray-curable composition was left to stand still, and the mass G₂ was mass of the active-energy-ray-curable composition obtained after the active-energy-ray-curable composition was left to stand still for 5 days in a constant temperature and humidity bath where a temperature was maintained at 60 degrees Celsius and a relative humidity was maintained at 30%. When the initial weight of the ink (the mass obtained before the still standing) was defined as the G₁ and the weight of the ink obtained after the still standing (the mass obtained after it was left to stand still for 5 days) was defined as the G₂, the volatilization rate was calculated by the following expression (1).

The volatilization rate (%)={(G₂−G₁)/G₁}×100 expression (1)

The constant temperature and humidity bath was PL-2J obtained from ESPEC CORP., and the dish was a flat dish FS-45 obtained from AS ONE Corporation. Here, the scores of 1, 2, and 3 in the evaluation criteria were considered to be practical.

--Evaluation Criteria--

3: The volatilization rate was 50% or less.

2: The volatilization rate was more than 50% but 60% or less.

1: The volatilization rate was more than 60% but 70% or less.

0: The volatilization rate was 70% or less.

<Crack Resistance of Coating Film>

The cured material obtained immediately after curing was bent at an angel of 180 degrees, and the printed coating film having a size of 3 cm×10 cm was drawn by 5 cm in a longitudinal direction (the coating film itself was drawn to 15 cm). At this time, the states of the respective coating films were visually observed, and were evaluated based on the following evaluation criteria. Here, the scores of 1 and 2 in the evaluation criteria were considered to be practical.

--Evaluation Criteria--

2: Even when the cured material was bent and drawn, no clack was found.

1: When the cured material was bent and drawn, minute crack was found.

0: When the cured material was bent and drawn, cracks were found.

<Granularity>

-Formation of Image for Measuring Granularity-

The produced ink ejection head (MH5440 model) was used to perform inkjet ejection on a substrate (PVC film), to form a black solid image (600 dpi) having a size of 3 cm×10 cm and an image density of 0.3. Moreover, solid images (600 dpi) of cyan and magenta having a size of 3 cm×10 cm and an image density of 0.3 were formed in the same manner.

A reflection-type color measuring meter X-Rite 939 (obtained from X-Rite) was used to measure the image density. The amount of the ink droplets ejected was adjusted to form an image of each ink having the same density.

The active-energy-ray-curable inks obtained in the aforementioned manner were found to have a viscosity of from 8 mPa·s through 15 mPa·s at an ejection temperature of from 25 degrees Celsius through 40 degrees Celsius.

The active-energy-ray-curable ink ejected on the substrate was cured by irradiation of light using an UV irradiator LH6 (D valve) (obtained from Fusion Systems Japan Co., Ltd.). The active-energy-ray-curable ink was cured in a wavelength region corresponding to the UVA region at 1 W/cm² under the light quantity condition of 3 J/cm². The solid coating film cured as described above was used as an image for evaluation.

-Evaluation of Granularity-

The obtained image of black, cyan, or magenta formed on the PVC film was visually observed, and was evaluated for granularity based on the following evaluation criteria. Here, the scores of 1, 2, and 3 in the evaluation criteria were considered to be practical.

--Evaluation Criteria--

3: No ink dot particles were found even when seen from a distance of less than 5 cm.

2: No ink dot particles were found even when seen from a distance of 5 cm or more but less than 30 cm.

1: Ink dot particles were found even when seen from a distance of 30 cm or more but less than 100 cm.

0: Ink dot particles were found even when seen from a distance of 100 cm or more.

TABLE 1

| | | | Glass transition | | |
|---|---|---|---|---|---|
| | | | temperature | | |
| Component | No | Compound | (TG, ° C.) | SP value | Manunufacturer's name and product's name |
| Polymerizable | A1-1 | [symbol] Acryloylmorpholine | 145 | 11.2 | KJ Chemicals Corporation “ACMO” |
| monomer | A1-2 | N-vinylcaprolactam | 90 | 10.8 | ISP Japan “VC” |
| | A1-3 | N-vinylpyrrolidone | 80 | 11.4 | ISP Japan “NVP” |
| | A1-4 | Hydroxyethyl acrylamide | 85 | 12.2 | KJ Chemicals Corporation “HEAA” |
| | A2-1 | 4-t-Butylcyclohexyl acrylate | 8 [symbol] | 8.7 | OSAKA ORGANIC CHEMICAL INDUSTRYY LTD. |
| | | | | | “TBCHA” |
| | A2-2 | Isobornyl acrylate | 97 | 9.3 | OSAKA ORGANIC CHEMICAL INDUSTRY LTD. |
| | | | | | “IBXA” |
| | A2-3 | 1-Adamantylacrylate | 153 | 10 | OSAKA ORGANIC CHEMICAL INDUSTRY LTD. |
| | | | | | “ADA” |
| | A3-1 | Dipropylene glycol diacrylate | 110 | 9. [symbol] | DAICEL-ALLNEX LTD. “DPGDA” |
| | A3-2 | Tripropylene glycol diacrylate | 80 | 9.2 | Shin Nakomura Chemical Co. Ltd. “APG-200” |
| | A3-3 | Pentaerythritol tetraacrylate | 103 | 10.3 | SARTOMER “ [symbol] 295N9” |
| | A3-4 | Dipentaerythritol pentaacrylate | 90 | 9.4 | SARTOMER “SR399 NS” |
| | B-1 | Phenoxyethyl acrylate | 2 | 10.1 | OSAKA ORGANIC CHEMICAL INDUSTRY LTD. |
| | | | | | “PKA” |
| | B-2 | Cyclic trimethylolpropane | 27 | 9.6 | OSAKA ORGANIC CHEMICAL INDUSTRY LTD. |
| | | formal acrylate | | | “CTFA” |
| Polymerizable | G-1 | CN963 (urethane acrylate oligomer) | 71 | — | SARTOMER “CN963” |
| oligomer | G-2 | CN2271 (polyester acrylate oligomer) | 42 | — | SARTOMER “CN2271” |
| Initiator | C-1 | 2,4,6-Trimethylbenzoyl- | — | — | BASF Japan [symbol] “IRGACORE TPO” |
| | | diphenylphosphine oxide | | | |
| | C-2 | 2,4-Diethylthioxanthen-9-one | — | — | Daido Chemical Corporation “DETX” |
| Polymerization | D-1 | [symbol] Methoxyphenol | — | — | Seiko Chemical Co. Ltd. “METHOQUINONE” |
| inhibitor | | | | | |
| Pigment | F-1 | Carbon block/BYKJET-9151 | — | — | — |
| dispersion | F-2 | Cyan pigment P [symbol] 15 [symbol] /SOLSPERSE 32000 | — | — | — |
| | F-3 | Magenta pigment P [symbol] 122/dispersant BYK | — | — | — |
| | | 9151 | | | |

[symbol]

indicates data missing or illegible when filed

TABLE 2

| | | Example | | | |
|---|---|---|---|---|---|
| | | 1 | 2 | 3 | 4 |
| Polymerizable monomer | A1-1 (SP value: 11.2, Tg: 145° C.) | 3.0 | 8.0 | 15.0 | 20.0 |
| where homopolymer has | A1-2 (SP value: 10.8, Tg: 90° C.) | — | — | — | — |
| glass transition | A1-3 (SP value: 11.4, Tg: 80° C.) | — | — | — | — |
| temperature of 80° C. | A1-4 (SP value: 12.2, Tg: 98° C.) | — | — | — | — |
| or more | A2-1 (SP value: 8.7, Tg: 85° C.) | — | — | — | — |
| | A2-2 (SP value: 9.3, Tg: 97° C.) | 25.0 | 25.0 | 20.0 | 18.0 |
| | A2-3 (SP value: 10, Tg: 153° C.) | — | — | — | — |
| | A3-1 (SP value: 9.5, Tg: 110° C.) | — | — | — | — |
| | A3-2 (SP value: 9.2, Tg: 90° C.) | — | — | — | — |
| | A3-3 (SP value: 10.3, Tg: 103° C.) | — | — | — | — |
| | A3-4 (SP value: 9.4, Tg: 90° C.) | — | — | — | — |
| Polymerizable monomer | B1-1 (SP value: 10.1, Tg: 2° C.) | 30.8 | 25.8 | 23.8 | 20.8 |
| other than the above | B1-2 (SP value: 9.6, Tg: 27° C.) | 15.0 | 15.0 | 15.0 | 15.0 |
| Polymerizable oligomer | G-1 (SP value: —, Tg: 71° C.) | — | — | — | — |
| | G-2 (SP value: —, Tg: 42° C.) | — | — | — | — |
| Polymerization initiator | C-1 | 10.0 | 10.0 | 10.0 | 10.0 |
| | C-2 | 2.0 | 2.0 | 2.0 | 2.0 |
| Polymerization inhibitor | D-1 | 0.2 | 0.2 | 0.2 | 0.2 |
| Pigment dispersion | F-1 | 14.0 | 14.0 | 14.0 | 14.0 |
| | F-2 | — | — | — | — |
| | F-3 | — | — | — | — |
| Amount of polymerizable monomer (A1) relative | | 3.0 | 8.0 | 15.0 | 20.0 |
| to total amount of composition (% by mass) | | | | | |
| Amount of polymerizable monomer where homopolymer has | | 28.0 | 33.0 | 35.0 | 38.0 |
| glass transition temperature of 80° C. or more relative | | | | | |
| to total amount ofcomposition (% by mass) | | | | | |
| Evaluation criteria | Liquid contact property | 2 | 2 | 2 | 2 |
| | Blocking property | 1 | 2 | 2 | 2 |
| | Adhesiveness | 1 | 2 | 3 | 3 |
| | Storage property | 2 | 2 | 2 | 2 |
| | Flexibility | 2 | 2 | 2 | 2 |
| | Odor | 2 | 2 | 2 | 2 |
| | Crack resistance of coating film | 1 | 1 | 1 | 1 |
| | Granularity | 1 | 1 | 1 | 1 |

TABLE 3

| | | Example | | | |
|---|---|---|---|---|---|
| | | 5 | 6 | 7 | 8 |
| Polymerizable monomer | A1-1 (SP value: 11.2, Tg: 145° C.) | 10.0 | 20.0 | — | — |
| where homopolymer has | A1-2 (SP value: 10.8, Tg: 90° C.) | — | — | 10.0 | — |
| glass transition | A1-3 (SP value: 11.4, Tg: 80° C.) | — | — | — | 10.0 |
| temperature of 80° C. | A1-4 (SP value: 12.2, Tg: 98° C.) | — | — | — | — |
| or more | A2-1 (SP value: 8.7, Tg: 85° C.) | — | — | — | — |
| | A2-2 (SP value: 9.3, Tg: 97° C.) | 20.0 | 26.0 | 25.0 | 25.0 |
| | A2-3 (SP value: 10, Tg: 153° C.) | — | — | — | — |
| | A3-1 (SP value: 9.5, Tg: 110° C.) | — | — | — | — |
| | A3-2 (SP value: 9.2, Tg: 90° C.) | — | — | — | — |
| | A3-3 (SP value: 10.3 Tg: 103° C.) | — | — | — | — |
| | A3-4 (SP value: 9.4, Tg: 90° C.) | — | — | — | — |
| Polymerizable monomer | B1-1 (SP value: 10.1, Tg: 2° C.) | 28.8 | 17.8 | 23.8 | 23.8 |
| other than the above | B1-2 (SP value: 9.6, Tg: 27° C.) | 15.0 | 10.0 | 15.0 | 15.0 |
| Polymerizable oligomer | G-1 (SP value: —, Tg: 71° C.) | — | — | — | — |
| | G-2 (SP value: —, Tg: 42° C.) | — | — | — | — |
| Polymerization initiator | C-1 | 10.0 | 10.0 | 10.0 | 10.0 |
| | C-2 | 2.0 | 2.0 | 2.0 | 2.0 |
| Polymerization inhibitor | D-1 | 0.2 | 0.2 | 0.2 | 0.2 |
| Pigment dispersion | F-1 | 14.0 | 14.0 | 14.0 | 14.0 |
| | F-2 | — | — | — | — |
| | F-3 | — | — | — | — |
| Amount of polymerizable monomer (A1) relative to total | | 10.0 | 20.0 | 10.0 | 10.0 |
| amount of composition (% by mass) | | | | | |
| Amount of polymerizable monomer where homopolymer has | | 30.0 | 46.0 | 35.0 | 35.0 |
| glass transition temperature of 80° C. or more relative | | | | | |
| to total amount of composition (% by mass) | | | | | |
| Evaluation criteria | Liquid contact property | 2 | 2 | 2 | 2 |
| | Blocking property | 1 | 2 | 2 | 2 |
| | Adhesiveness | 3 | 3 | 3 | 3 |
| | Storage property | 2 | 2 | 1 | 1 |
| | Flexibility | 2 | 1 | 2 | 2 |
| | Odor | 2 | 1 | 2 | 2 |
| | Crack resistance of coating film | 1 | 1 | 1 | 1 |
| | Granularity | 1 | 1 | 1 | 1 |

TABLE 4

| | | Example | | | |
|---|---|---|---|---|---|
| | | 9 | 10 | 11 | 12 |
| Polymerizable monomer | A1-1 (SP value: 11.2, Tg: 145° C.) | — | — | 15.0 | 12.0 |
| where homopolymer has | A1-2 (SP value: 10.8, Tg: 90° C.) | 10.0 | 5.0 | — | — |
| glass transition | A1-3 (SP value: 11.4, Tg: 80° C.) | 10.0 | 2.0 | — | — |
| temperature of 80° C. | A1-4 (SP value: 12.2, Tg: 98° C.) | — | 2.0 | — | — |
| or more | A2-1 (SP value: 8.7, Tg: 85° C.) | — | 10.0 | 20.0 | — |
| | A2-2 (SP value: 9.3, Tg: 97° C.) | — | 10.0 | — | 10.0 |
| | A2-3 (SP value: 10, Tg: 153° C.) | — | 12.0 | — | 10.0 |
| | A3-1 (SP value: 9.5, Tg: 110° C.) | — | — | — | — |
| | A3-2 (SP value: 9.2, Tg: 90° C.) | — | — | — | — |
| | A3-3 (SP value: 10.3, Tg: 103° C.) | — | — | — | — |
| | A3-4 (SP value: 9.4, Tg: 90° C.) | — | — | — | — |
| Polymerizable monomer | B1-1 (SP value: 10.1, Tg: 2° C.) | 28.8 | 20.8 | 23.8 | 26.8 |
| other than the above | B1-2 (SP value: 9.6, Tg: 27° C.) | 25.0 | 12.0 | 15.0 | 15.0 |
| Polymerizable oligomer | G-1 (SP value: —, Tg: 71° C.) | — | — | — | — |
| | G-2 (SP value: —, Tg: 42° C.) | — | — | — | — |
| Polymerization initiator | C-1 | 10.0 | 10.0 | 10.0 | 10.0 |
| | C-2 | 2.0 | 2.0 | 2.0 | 2.0 |
| Polymerization inhibitor | D-1 | 0.2 | 0.2 | 0.2 | 0.2 |
| Pigment dispersion | F-1 | 14.0 | 14.0 | 14.0 | 14.0 |
| | F-2 | — | — | — | — |
| | F-3 | — | — | — | — |
| Amount of polymerizable monomer (A1) relative to total | | 20.0 | 9.0 | 15.0 | 12.0 |
| amount of composition (% by mass) | | | | | |
| Amount of polymerizable monomer where homopolymer has | | 20.0 | 41.0 | 35.0 | 32.0 |
| glass transition temperature of 80° C. or more relative | | | | | |
| to total amount of composition (% by mass) | | | | | |
| Evaluation criteria | Liquid contact property | 2 | 2 | 2 | 2 |
| | Blocking property | 1 | 2 | 2 | 2 |
| | Adhesiveness | 3 | 2 | 3 | 2 |
| | Storage property | 1 | 1 | 2 | 2 |
| | Flexibility | 2 | 2 | 2 | 2 |
| | Odor | 2 | 2 | 2 | 2 |
| | Crack resistance of coating film | 1 | 1 | 1 | 1 |
| | Granularity | 1 | 1 | 1 | 1 |

TABLE 5

| | | Example | | | |
|---|---|---|---|---|---|
| | | 13 | 14 | 15 | 16 |
| Polymerizable monomer | A1-1 (SP value: 11.2, Tg: 145° C.) | 15.0 | 15.0 | 15.0 | 15.0 |
| where homopolymer has | A1-2 (SP value: 10.8, Tg: 90° C.) | — | — | — | — |
| glass transition | A1-3 (SP value: 11.4, Tg: 80° C.) | — | — | — | — |
| temperature of 80° C. | A1-4 (SP value: 12.2, Tg: 98° C.) | — | — | — | — |
| or more | A2-1 (SP value: 8.7, Tg: 85° C.) | — | — | — | — |
| | A2-2 (SP value: 9.3, Tg: 97° C.) | 20.0 | 20.0 | 20.0 | 20.0 |
| | A2-3 (SP value: 10, Tg: 153° C.) | — | — | — | — |
| | A3-1 (SP value: 9.5, Tg: 110° C.) | 5.0 | 3.0 | — | 3.0 |
| | A3-2 (SP value: 9.2, Tg: 90° C.) | — | 2.0 | 5.0 | — |
| | A3-3 (SP value: 10.3, Tg: 103° C.) | — | — | 2.0 | — |
| | A3-4 (SP value: 9.4, Tg: 90° C.) | — | 2.0 | — | 2.0 |
| Polymerizable monomer | B1-1 (SP value: 10.1, Tg: 2° C.) | 18.8 | 16.8 | 16.8 | 18.8 |
| other than the above | B1-2 (SP value: 9.6, Tg: 27° C.) | 15.0 | 15.0 | 15.0 | 15.0 |
| Polymerizable oligomer | G-1 (SP value: —, Tg: 71° C.) | — | — | — | — |
| | G-2 (SP value: —, Tg: 42° C.) | — | — | — | — |
| Polymerization initiator | C-1 | 10.0 | 10.0 | 10.0 | 10.0 |
| | C-2 | 2.0 | 2.0 | 2.0 | 2.0 |
| Polymerization inhibitor | D-1 | 0.2 | 0.2 | 0.2 | 0.2 |
| Pigment dispersion | F-1 | 14.0 | 14.0 | 14.0 | 14.0 |
| | F-2 | — | — | — | — |
| | F-3 | — | — | — | — |
| Amount of polymerizable monomer (A1) relative to total | | 15.0 | 15.0 | 15.0 | 15.0 |
| amount of composition (% by mass) | | | | | |
| Amount of polymerizable monomer where homopolymer has | | 40.0 | 42.0 | 42.0 | 40.0 |
| glass transition temperature of 80° C. or more relative | | | | | |
| to total amount of composition (% by mass) | | | | | |
| Evaluation criteria | Liquid contact property | 2 | 2 | 2 | 2 |
| | Blocking property | 3 | 3 | 3 | 3 |
| | Adhesiveness | 3 | 3 | 3 | 3 |
| | Storage property | 2 | 2 | 2 | 2 |
| | Flexibility | 2 | 2 | 2 | 2 |
| | Odor | 2 | 2 | 2 | 2 |
| | Crack resistance of coating film | 1 | 1 | 1 | 1 |
| | Granularity | 1 | 1 | 1 | 1 |

TABLE 6

| | | Example | | | |
|---|---|---|---|---|---|
| | | 17 | 18 | 19 | 20 |
| Polymerizable monomer | A1-1 (SP value: 11.2, Tg: 145° C.) | 3.0 | 3.0 | 15.0 | 15.0 |
| where homopolymer has | A1-2 (SP value: 10.8, Tg: 90° C.) | — | — | — | — |
| glass transition | A1-3 (SP value: 11.4, Tg: 80° C.) | — | — | — | — |
| temperature of 80° C. | A1-4 (SP value: 12.2, Tg: 98° C.) | — | — | — | — |
| or more | A2-1 (SP value: 8.7, Tg: 85° C.) | — | — | — | — |
| | A2-2 (SP value: 9.3, Tg: 97° C.) | 20.0 | 20.0 | 20.0 | 20.0 |
| | A2-3 (SP value: 10, Tg: 153° C.) | — | — | — | — |
| | A3-1 (SP value: 9.5, Tg: 110° C.) | 5.0 | 7.0 | — | — |
| | A3-2 (SP value: 9.2, Tg: 90° C.) | — | — | — | — |
| | A3-3 (SP value: 10.3, Tg: 103° C.) | 2.0 | — | — | — |
| | A3-4 (SP value: 9.4, Tg: 90° C.) | 2.0 | — | — | — |
| Polymerizable monomer | B1-1 (SP value: 10.1, Tg: 2° C.) | 30.8 | 41.8 | 22.8 | 18.8 |
| other than the above | B1-2 (SP value: 9.6, Tg: 27° C.) | 11.0 | 6.0 | 15.0 | 15.0 |
| Polymerizable oligomer | G-1 (SP value: —, Tg: 71° C.) | — | — | 1.0 | |
| | G-2 (SP value: —, Tg: 42° C.) | — | — | | 5.0 |
| Polymerization initiator | C-1 | 10.0 | 10.0 | 10.0 | 10.0 |
| | C-2 | 2.0 | 2.0 | 2.0 | 2.0 |
| Polymerization inhibitor | D-1 | 0.2 | 0.2 | 0.2 | 0.2 |
| Pigment dispersion | F-1 | 14.0 | 10.0 | 14.0 | 14.0 |
| | F-2 | — | — | — | — |
| | F-3 | — | — | — | — |
| Amount of polymerizable monomer (A1) relative to total | | 3.0 | 3.0 | 15.0 | 15.0 |
| amount of composition (% by mass) | | | | | |
| Amount of polymerizable monomer where homopolymer has | | 32.0 | 30.0 | 35.0 | 35.0 |
| glass transition temperature of 80° C. or more relative | | | | | |
| to total amount of composition (% by mass) | | | | | |
| Evaluation criteria | Liquid contact property | 2 | 2 | 2 | 2 |
| | Blocking property | 2 | 2 | 2 | 2 |
| | Adhesiveness | 1 | 1 | 3 | 3 |
| | Storage property | 2 | 2 | 2 | 2 |
| | Flexibility | 2 | 2 | 2 | 2 |
| | Odor | 3 | 3 | 2 | 1 |
| | Crack resistance of coating film | 1 | 1 | 2 | 2 |
| | Granularity | 1 | 1 | 1 | 1 |

TABLE 7

| | | Example | | | |
|---|---|---|---|---|---|
| | | 21 | 22 | 23 | 24 |
| Polymerizable monomer | A1-1 (SP value: 11.2, Tg: 145° C.) | 15.0 | 15.0 | 15.0 | 15.0 |
| where homopolymer has | A1-2 (SP value: 10.8, Tg: 90° C.) | — | — | — | — |
| glass transition | A1-3 (SP value: 11.4, Tg: 80° C.) | — | — | — | — |
| temperature of 80° C. | A1-4 (SP value: 12.2, Tg: 98° C.) | — | — | — | — |
| or more | A2-1 (SP value: 8.7, Tg: 85° C.) | — | — | — | — |
| | A2-2 (SP value: 9.3, Tg: 97° C.) | 20.0 | 20.0 | 20.0 | 20.0 |
| | A2-3 (SP value: 10, Tg: 153° C.) | — | — | — | — |
| | A3-1 (SP value: 9.5, Tg: 110° C.) | — | — | — | — |
| | A3-2 (SP value: 9.2, Tg: 90° C.) | — | — | — | — |
| | A3-3 (SP value: 10.3, Tg: 103° C.) | — | — | — | — |
| | A3-4 (SP value: 9.4, Tg: 90° C.) | — | — | — | — |
| Polymerizable monomer | B1-1 (SP value: 10.1, Tg: 2° C.) | 23.8 | 33.8 | 35.8 | 23.8 |
| other than the above | B1-2 (SP value: 9.6, Tg: 27° C.) | 15.0 | 15.0 | 15.0 | 15.0 |
| Polymerizable oligomer | G-1 (SP value: —, Tg: 71° C.) | — | — | — | — |
| | G-2 (SP value: —, Tg: 42° C.) | — | — | — | — |
| Polymerization initiator | C-1 | 10.0 | 10.0 | 10.0 | 10.0 |
| | C-2 | 2.0 | 2.0 | 2.0 | 2.0 |
| Polymerization inhibitor | D-1 | 0.2 | 0.2 | 0.2 | 0.2 |
| Pigment dispersion | F-1 | — | — | — | — |
| | F-2 | 14.0 | 4.0 | 2.0 | — |
| | F-3 | — | — | — | 14.0 |
| Amount of polymerizable monomer (A1) relative to total | | 15.0 | 15.0 | 15.0 | 15.0 |
| amount of composition (% by mass) | | | | | |
| Amount of polymerizable monomer where homopolymer has | | 35.0 | 35.0 | 35.0 | 35.0 |
| glass transition temperature of 80° C. or more relative | | | | | |
| to total amount of composition (% by mass) | | | | | |
| Evaluation criteria | Liquid contact property | 2 | 2 | 2 | 2 |
| | Blocking property | 2 | 2 | 2 | 2 |
| | Adhesiveness | 3 | 3 | 3 | 3 |
| | Storage property | 2 | 2 | 2 | 2 |
| | Flexibility | 2 | 2 | 2 | 2 |
| | Odor | 2 | 2 | 3 | 2 |
| | Crack resistance of coating film | 1 | 1 | 1 | 1 |
| | Granularity | 1 | 2 | 3 | 1 |

TABLE 8

| | | Example | | |
|---|---|---|---|---|
| | | 25 | 26 | 27 |
| Polymerizable monomer | A1-1 (SP value: 11.2, Tg: 145° C.) | 15.0 | 15.0 | 15.0 |
| where homopolymer has | A1-2 (SP value: 10.8, Tg: 90° C.) | — | — | — |
| glass transition | A1-3 (SP value: 11.4, Tg: 80° C.) | — | — | — |
| temperature of 80° C. | A1-4 (SP value: 12.2, Tg: 98° C.) | — | — | — |
| or more | A2-1 (SP value: 8.7, Tg: 85° C.) | — | — | — |
| | A2-2 (SP value: 9.3, Tg: 97° C.) | 20.0 | 20.0 | 20.0 |
| | A2-3 (SP value: 10, Tg: 153° C.) | — | — | — |
| | A3-1 (SP value: 9.5, Tg: 110° C.) | — | — | 5.0 |
| | A3-2 (SP value: 9.2, Tg: 90° C.) | — | — | — |
| | A3-3 (SP value: 10.3, Tg: 103° C.) | — | — | — |
| | A3-4 (SP value: 9.4, Tg: 90° C.) | — | — | — |
| Polymerizable monomer | B1-1 (SP value: 10.1, Tg: 2° C.) | 33.8 | 35.8 | 30.8 |
| other than the above | B1-2 (SP value: 9.6, Tg: 27° C.) | 15.0 | 15.0 | 3.0 |
| Polymerizable oligomer | G-1 (SP value: —, Tg: 71° C.) | — | — | — |
| | G-2 (SP value: —, Tg: 42° C.) | — | — | — |
| Polymerization initiator | C-1 | 10.0 | 10.0 | 10.0 |
| | C-2 | 2.0 | 2.0 | 2.0 |
| Polymerisation inhibitor | D-1 | 0.2 | 0.2 | 0.2 |
| Pigment dispersion | F-1 | — | — | 14.0 |
| | F-2 | — | — | — |
| | F-3 | 4.0 | 2.0 | — |
| Amount of polymerizable monomer (A1) relative to total | | 15.0 | 15.0 | 15.0 |
| amount of composition (% by mass) | | | | |
| Amount of polymerizable monomer where homopolymer has | | 35.0 | 35.0 | 40.0 |
| glass transition temperature of 80° C. or more relative | | | | |
| to total amount of composition (% by mass) | | | | |
| Evaluation criteria | Liquid contact property | 2 | 2 | 2 |
| | Blocking property | 2 | 2 | 3 |
| | Adhesiveness | 3 | 3 | 3 |
| | Storage property | 2 | 2 | 2 |
| | Flexibility | 2 | 2 | 2 |
| | Odor | 2 | 3 | 3 |
| | Crack resistance of coating film | 1 | 1 | 1 |
| | Granularity | 2 | 3 | 1 |

TABLE 9

| | | Comparative Example | | | |
|---|---|---|---|---|---|
| | | 1 | 2 | 3 | 4 |
| Polymerizable monomer | A1-1 (SP value: 11.2, Tg: 145° C.) | — | 30.0 | — | 16.0 |
| where homopolymer has | A1-2 (SP value: 10.8, Tg: 90° C.) | — | — | 15.0 | — |
| glass transition | A1-3 (SP value: 11.4, Tg: 80° C.) | — | — | 15.0 | — |
| temperture of 80° C. | A1-4 (SP value: 12.2, Tg: 98° C.) | — | — | — | — |
| or more | A2-1 (SP value: 8.7, Tg: 85° C.) | — | — | — | — |
| | A2-2 (SP value: 9.3, Tg: 97° C.) | 30.0 | — | — | — |
| | A2-3 (SP value: 10, Tg: 153° C.) | — | — | — | — |
| | A3-1 (SP value: 9.5, Tg: 110° C.) | — | — | — | — |
| | A3-2 (SP value: 9.2, Tg: 90° C.) | — | — | — | — |
| | A3-3 (SP value: 10.3, Tg: 103° C.) | — | — | — | — |
| | A3-4 (SP value: 9.4, Tg: 90° C.) | — | — | — | — |
| Polymerizable monomer | B1-1 (SP value: 10.1, Tg: 2° C.) | 28.8 | 33.8 | 33.8 | 50.8 |
| other than the above | B1-2 (SP value: 9.6, Tg: 27° C.) | 15.0 | 10.0 | 10.0 | 13.0 |
| Polymerizable oligomer | G-1 (SP value: —, Tg: 71° C.) | — | — | — | — |
| | G-2 (SP value: —, Tg: 42° C.) | — | — | — | — |
| Polymerization initiator | C-1 | 10.0 | 10.0 | 10.0 | 10.0 |
| | C-2 | 2.0 | 2.0 | 2.0 | 2.0 |
| Polymerization inhibitor | D-1 | 0.2 | 0.2 | 0.2 | 0.2 |
| Pigment dispersion | F-1 | 14.0 | 14.0 | 14.0 | 14.0 |
| | F-2 | — | — | — | — |
| | F-3 | — | — | — | — |
| Amount of polymerizable monomer (A1) relative to total | | 0.0 | 30.0 | 30.0 | 10.0 |
| amount of composition (% by mass) | | | | | |
| Amount of polymerizable monomer where homopolymer has | | 30.0 | 30.0 | 30.0 | 10.0 |
| glass transition temperature of 80° C. or more relative | | | | | |
| to total amount of composition (% by mass) | | | | | |
| Evaluation criteria | Liquid contact property | 2 | 0 | 0 | 2 |
| | Blocking property | 0 | 1 | 1 | 0 |
| | Adhesiveness | 0 | 3 | 3 | 3 |
| | Storage property | 2 | 2 | 1 | 2 |
| | Flexibility | 2 | 2 | 2 | 2 |
| | Odor | 2 | 1 | 1 | 3 |
| | Crack resistance of coating film | 1 | 1 | 1 | 1 |
| | Granularity | 1 | 1 | 1 | 1 |

TABLE 10

| | | Comparative Example | |
|---|---|---|---|
| | | 5 | 6 |
| Polymerizable monomer | A1-1 (SP value: 11.2, Tg: 145° C.) | 1.0 | — |
| where homopolymer has | A1-2 (SP value: 10.8, Tg: 90° C.) | — | — |
| glass transition | A1-3 (SP value: 11.4, Tg: 80° C.) | — | — |
| temperature of 80° C. | A1-4 (SP value: 12.2, Tg: 98° C.) | — | — |
| or more | A2-1 (SP value: 8.7, Tg: 85° C.) | — | — |
| | A2-2 (SP value: 9.3, Tg: 97° C.) | 27.0 | 40.0 |
| | A2-3 (SP value: 10, Tg: 153° C.) | — | — |
| | A3-1 (SP value: 9.5, Tg: 110° C.) | — | — |
| | A3-2 (SP value: 9.2, Tg: 90° C.) | — | — |
| | A3-3 (SP value: 10.3, Tg: 103° C.) | — | — |
| | A3-4 (SP value: 9.4, Tg: 90° C.) | — | — |
| Polymerizable monomer | B1-1 (SP value: 10.1, Tg: 2° C.) | 30.8 | — |
| other than the above | B1-2 (SP value: 9.6, Tg: 27° C.) | 15.0 | 33.8 |
| Polymerizable oligomer | G-1 (SP value: —, Tg: 71° C.) | — | — |
| | G-2 (SP value: —, Tg: 42° C.) | — | — |
| Polymerization initiator | C-1 | 10.0 | 10.0 |
| | C-2 | 2.0 | 2.0 |
| Polymerization inhibitor | D-1 | 0.2 | 0.2 |
| Pigment dispersion | F-1 | 14.0 | 14.0 |
| | F-2 | — | — |
| | F-3 | — | — |
| Amount of polymerizable monomer (A1) relative to total | | 1.0 | 0.0 |
| amount of composition (% by mass) | | | |
| Amount of polymerizable monomer where homopolymer has | | 28.0 | 40.0 |
| glass transition temperature of 80° C. or more relative | | | |
| to total amount of composition (% by mass) | | | |
| Evaluation criteria | Liquid contact property | 2 | 2 |
| | Blocking property | 0 | 0 |
| | Adhesiveness | 0 | 0 |
| | Storage property | 2 | 2 |
| | Flexibility | 2 | 2 |
| | Odor | 2 | 1 |
| | Crack resistance of coating film | 1 | 1 |
| | Granularity | 1 | 1 |

Aspects of the present disclosure are as follows, for example.

<1> An active-energy-ray-curable composition including

at least two or more kinds of polymerizable monomers (A) where a homopolymer of each of the polymerizable monomers (A) has a glass transition temperature of 80 degrees Celsius or more,

wherein the polymerizable monomers (A) have a polymerizable monomer (A1) where a homopolymer of the polymerizable monomer (A1) has an SP value of 10.8 or more but 12.2 or less determined by a Fedors method, and

an amount of the polymerizable monomer (A1) is 3% by mass or more but 20% by mass or less relative to a total amount of the active-energy-ray-curable composition.

<2> The active-energy-ray-curable composition according to <1>, wherein the amount of the polymerizable monomer (A1) is 8% by mass or more but 20% by mass or less relative to the total amount of the active-energy-ray-curable composition.

<3> The active-energy-ray-curable composition according to <1> or <2>, wherein the polymerizable monomer (A1) includes 4-acryloylmorpholine.

<4> The active-energy-ray-curable composition according to any one of <1> to <3>, wherein a total amount of the polymerizable monomers (A) where the homopolymer of each of the polymerizable monomers (A) has the glass transition temperature of 80 degrees Celsius or more is 35% by mass or more but 45% by mass or less relative to the total amount of the active-energy-ray-curable composition.

<5> The active-energy-ray-curable composition according to any one of <1> to <4>, wherein the polymerizable monomers (A) further include a polymerizable monomer (A3) having at least two or more polymerizable functional groups.

<6> The active-energy-ray-curable composition according to any one of <1> to <5>, wherein a volatilization rate (%) of the active-energy-ray-curable composition is 50% or less, the volatilization rate (%) being determined by dividing a value by mass G₁, the value being obtained by subtracting the mass G₁ from mass G₂, where the mass G₁ is mass of the active-energy-ray-curable composition obtained before the active-energy-ray-curable composition is left to stand still, and the mass G₂ is mass of the active-energy-ray-curable composition obtained after the active-energy-ray-curable composition is left to stand still for 5 days in a thermostat bath where a temperature is maintained at 60 degrees Celsius and a relative humidity is maintained at 30%.

<7> The active-energy-ray-curable composition according to any one of <1> to <6>, further including

a polymerizable oligomer.

<8> An active-energy-ray-curable ink including

at least two or more kinds of polymerizable monomers (A) where a homopolymer of each of the polymerizable monomers (A) has a glass transition temperature of 80 degrees Celsius or more,

wherein the polymerizable monomers (A) have a polymerizable monomer (A1) where a homopolymer of the polymerizable monomer (A1) has an SP value of 10.8 or more but 12.2 or less determined by a Fedors method, and

an amount of the polymerizable monomer (A1) is 3% by mass or more but 20% by mass or less relative to a total amount of the active-energy-ray-curable composition.

<9> An ink set including:

a black ink;

a cyan ink;

a yellow ink;

a magenta ink; and

a white ink,

wherein at least one selected from the group consisting of the black ink, the cyan ink, the yellow ink, the magenta ink, and the white ink in the ink set includes the active-energy-ray-curable composition according to any one of <1> to <7> and a colorant.

<10> The ink set according to <9>, further including at least one selected from the group consisting of a light cyan ink and a light magenta ink.

<11> A stored container including:

a container; and

at least one selected from the group consisting of the active-energy-ray-curable composition according to any one of <1> to <7>, the active-energy-ray-curable ink according to <8>, and the ink in the ink set according to <9> or <10>.

<12> The stored container according to <11>, further including:

a spout provided with a sealing film;

a cap body that is screwed with the spout, and

an independent ring-shaped opening preventing member, the independent ring-shaped opening preventing member being provided between an inner cap of the cap body and a main body of the cap body, and being configured to prevent rotation in an opening direction in an unused state.

<13> An image forming apparatus including:

an ejection unit configured to eject at least one selected from the group consisting of the active-energy-ray-curable composition according to any one of <1> to <7>, the active-energy-ray-curable ink according to <8>, and the ink in the ink set according to <9> or <10>, which is stored in a stored container; and

an irradiation unit configured to irradiate the active-energy-ray-curable composition or the ink ejected with active energy rays,

wherein the ejection unit includes a liquid chamber, a nozzle plate that has a nozzle hole through which the active-energy-ray-curable composition or the ink is ejected, and a flow path, and

at least one selected from the group consisting of a member constituting the liquid chamber, a member constituting the nozzle plate, and a member constituting the flow path is joined with an adhesive at one or more portions.

<14> The image forming apparatus according to <13>,

wherein the adhesive is an epoxy adhesive.

<15> An image forming method including

forming an image with the image forming apparatus according to <13> or <14>.

<16> A printed matter including

a cured material obtained by curing the active-energy-ray-curable composition according to any one of <1> to <7>.

The active-energy-ray-curable composition according to any one of <1> to <7>, the active-energy-ray-curable ink according to <8>, the ink set according to <9> or <10>, the stored container according to <11> or <12>, the image forming apparatus according to <13> or <14>, the image forming method according to <15>, and the cured material according to <16> can solve the conventionally existing problems in the art and can achieve the object of the present disclosure.

### REFERENCE SIGNS LIST

1 storing pool (storing part)
3 movable stage
4 active energy rays
5 composition
6 cured layer
30 ejection head unit for additive manufacturing
31, 32 ejection head unit for support
33, 34 ultraviolet irradiator
35 solid object
36 additive manufacturing support
37 substrate for additive manufacturing
38 stage
39 image forming apparatus

1: An active-energy-ray-curable composition, comprising:
at least two or more kinds of polymerizable monomers (A) where a homopolymer of each of the polymerizable monomers (A) has a glass transition temperature of 80 degrees Celsius or more,
wherein the polymerizable monomers (A) have a polymerizable monomer (A1) where a homopolymer of the polymerizable monomer (A1) has an SP value of 10.8 or more but 12.2 or less determined by a Fedors method, and
an amount of the polymerizable monomer (A1) is 3% by mass or more but 20% by mass or less relative to a total amount of the active-energy-ray-curable composition.

2: The active-energy-ray-curable composition according to claim 1, wherein the amount of the polymerizable monomer (A1) is 8% by mass or more but 20% by mass or less relative to the total amount of the active-energy-ray-curable composition.

3: The active-energy-ray-curable composition according to claim wherein the polymerizable monomer (A1) includes 4-acryloylmorpholine.

4: The active-energy-ray-curable composition according to claim 1, wherein a total amount of the polymerizable monomers (A) where the homopolymer of each of the polymerizable monomers (A) has the glass transition temperature of 80 degrees Celsius or more is 35% by mass or more but 45% by mass or less relative to the total amount of the active-energy-ray-curable composition.

5: The active-energy-ray-curable composition according tip claim 1, wherein the polymerizable monomers (A) further include a polymerizable monomer (A3) having at least two or more polymerizable functional groups.

6: The active-energy-ray-curable composition according to claim 1, wherein a volatilization rate (%) of the active-energy-ray-curable composition is 50% or less, the volatilization rate (%) being determined by dividing a value by mass G1, the value being obtained by subtracting the mass G1 from mass G2, where the mass G1 is a mass of the active-energy-ray-curable composition obtained before the active-energy-ray-curable composition is left to stand still, and the mass G2 is mass of the active-energy-ray-curable composition obtained after the active-energy-ray-curable composition is left to stand still for 5 days in a thermostat bath where a temperature is maintained at 60 degrees Celsius and a relative humidity is maintained at 30%.

7: The active-energy-ray-curable composition according to claim 1, further comprising:
a polymerizable oligomer.

8: An ink set, comprising:
a black ink;
a cyan ink;
a yellow ink;
a magenta ink; and
a white ink,
wherein at least one selected from the group consisting of the black ink, the cyan ink, the yellow ink, the magenta ink, and the white ink in the ink set includes the active-energy-ray-curable composition according to claim 1 and a colorant.

9: The ink set according to claim 8, further comprising:
at least one selected from the group consisting of a light cyan ink and a light magenta ink.

10: A composition stored container, comprising:
a container; and
the active-energy-ray-curable composition according to claim 1, stored in the container.

11: The composition stored container according to claim 10, further comprising:
a spout provided with a sealing film;
a cap body that is screwed with the spout, and
an independent ring-shaped opening preventing member, the independent ring-shaped opening preventing member being provided between an inner cap of the cap body and a main body of the cap body, and being configured to prevent rotation in an opening direction in an unused state.

12: An image forming apparatus, comprising:
an ejection unit configured to eject the active-energy-ray-curable composition according to claim 1, which is stored in a composition stored container; and
an irradiation unit configured to irradiate the active-energy-ray-curable composition ejected with active energy rays,
wherein the ejection unit includes a liquid chamber, a nozzle plate that has a nozzle hole through which the active-energy-ray-curable composition is ejected, and a flow path, and
at least one selected from the group consisting of a member constituting the liquid chamber, a member constituting the nozzle plate, and a member constituting the flow path is joined with an adhesive at one or more portions.

13: The image forming apparatus according to claim 12, wherein the adhesive is an epoxy adhesive.

14: An image forming method, comprising:
forming an image with the image forming apparatus according to claim 12.

15: A printed matter, comprising:
a cured material obtained by curing the active-energy-ray-curable composition according to claim 1.
